(19) United States
(12) Patent Application Publication
(10) Pub. No.: US 2025/0286599 A1
(43) Pub. Date: Sep. 11, 2025

(54) REPORTING CROSS-LINK INTERFERENCE ASSOCIATED WITH AN ELECTROMAGNETIC RADIATION REFLECTION RELAY SERVICE

(71) Applicant: QUALCOMM Incorporated, San Diego, CA (US)

(72) Inventors: Yuwei REN, Beijing (CN); Yan ZHOU, San Diego, CA (US); Huilin XU, Temecula, CA (US); Qian ZHANG, Basking Ridge, NJ (US)

(21) Appl. No.: 18/861,768

(22) PCT Filed: Jun. 22, 2022
(86) PCT No.: PCT/CN2022/100327

§ 371 Date: Oct. 30, 2024

(51) Int. Cl. H04B 7/06; H04B 7/155; H04L 25/02

(52) U.S. Cl. CPC H04B 7/0634; H04B 7/15528; H04L 25/0226

(57) ABSTRACT

Various aspects of the present disclosure generally relate to wireless communication. In some aspects, a first network node may receive a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node. The first network node may transmit channel estimation information corresponding to the signal. Numerous other aspects are described.

### FIELD OF THE DISCLOSURE

Aspects of the present disclosure generally relate to wireless communication and to techniques and apparatuses for reporting cross-link interference associated with an electromagnetic radiation reflection relay service.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first network node for wireless communication. The first network node may include a memory and one or more processors coupled to the memory. The one or more processors may be configured to receive a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node. The one or more processors may be configured to transmit channel estimation information corresponding to the signal, wherein the channel estimation information includes first channel estimation information and second channel estimation information, wherein the first channel estimation information corresponds to the first communication channel and is based on the first pre-coding vector, and wherein the second channel estimation information corresponds to the second communication channel and is based on a second pre-coding vector associated with the second communication channel

Some aspects described herein relate to a first network node for wireless communication. The first network node may include a memory and one or more processors coupled to the memory. The one or more processors may be configured to transmit cross-link interference (CLI) configuration information that includes first information indicative of a reference signal resource. The one or more processors may be configured to receive channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and wherein the second channel estimation information corresponds to a second communication channel between an electromagnetic radiation reflection relay network node and the third network node and is based on a second pre-coding vector associated with the second communication channel. The one or more processors may be configured to transmit reflection relay configuration information to the electromagnetic radiation reflection relay network node, wherein the reflection relay configuration information is indicative of one or more electromagnetic reflection parameters based on the channel estimation information.

Some aspects described herein relate to a first network node for wireless communication. The first network node may include a memory and one or more processors coupled to the memory. The one or more processors may be configured to receive, from an aggressor network node, a plurality of aggressor reference signals, wherein the plurality of aggressor reference signals includes a first aggressor reference signal pre-coded by first pre-coding information and a second aggressor reference signal pre-coded by second pre-coding information. The one or more processors may be configured to receive, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time. The one or more processors may be configured to transmit, to a second network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and wherein the second channel information is indicative of one or more channel characteristics corresponding to a second channel between the first network node and the electromagnetic radiation reflection relay network node.

Some aspects described herein relate to a method of wireless communication performed by a first network node. The method may include receiving a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node. The method may include transmitting channel estimation information corresponding to the signal, wherein the channel estimation information includes first channel estimation information and second channel estimation information, wherein the first channel estimation information corresponds to the first communication channel and is based on the first pre-coding vector, and wherein the second channel estimation information corresponds to the second communication channel and is based on a second pre-coding vector associated with the second communication channel.

Some aspects described herein relate to a method of wireless communication performed by a first network node. The method may include transmitting CLI configuration information that includes first information indicative of a reference signal resource. The method may include receiving channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and wherein the second channel estimation information corresponds to a second communication channel between an electromagnetic radiation reflection relay network node and the third network node and is based on a second pre-coding vector associated with the second communication channel. The method may include transmitting reflection relay configuration information to the electromagnetic radiation reflection relay network node, wherein the reflection relay configuration information is indicative of one or more electromagnetic reflection parameters based on the channel estimation information.

Some aspects described herein relate to a method of wireless communication performed by a first network node. The method may include receiving, from an aggressor network node, a plurality of aggressor reference signals, wherein the plurality of aggressor reference signals includes a first aggressor reference signal pre-coded by first pre-coding information and a second aggressor reference signal pre-coded by second pre-coding information. The method may include receiving, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time. The method may include transmitting, to a second network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and wherein the second channel information is indicative of one or more channel characteristics corresponding to a second channel between the first network node and the electromagnetic radiation reflection relay network node.

Some aspects described herein relate to a non-transitory computer-readable medium that stores a set of instructions for wireless communication by a first network node. The set of instructions, when executed by one or more processors of the first network node, may cause the first network node to receive a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node. The set of instructions, when executed by one or more processors of the first network node, may cause the first network node to transmit channel estimation information corresponding to the signal, wherein the channel estimation information includes first channel estimation information and second channel estimation information, wherein the first channel estimation information corresponds to the first communication channel and is based on the first pre-coding vector, and wherein the second channel estimation information corresponds to the second communication channel and is based on a second pre-coding vector associated with the second communication channel.

Some aspects described herein relate to a non-transitory computer-readable medium that stores a set of instructions for wireless communication by a first network node. The set of instructions, when executed by one or more processors of the first network node, may cause the first network node to transmit CLI configuration information that includes first information indicative of a reference signal resource. The set of instructions, when executed by one or more processors of the first network node, may cause the first network node to receive channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and wherein the second channel estimation information corresponds to a second communication channel between an electromagnetic radiation reflection relay network node and the third network node and is based on a second pre-coding vector associated with the second communication channel. The set of instructions, when executed by one or more processors of the first network node, may cause the first network node to transmit reflection relay configuration information to the electromagnetic radiation reflection relay network node, wherein the reflection relay configuration information is indicative of one or more electromagnetic reflection parameters based on the channel estimation information.

Some aspects described herein relate to a non-transitory computer-readable medium that stores a set of instructions for wireless communication by a first network node. The set of instructions, when executed by one or more processors of the first network node, may cause the first network node to receive, from an aggressor network node, a plurality of aggressor reference signals, wherein the plurality of aggressor reference signals includes a first aggressor reference signal pre-coded by first pre-coding information and a second aggressor reference signal pre-coded by second pre-coding information. The set of instructions, when executed by one or more processors of the first network node, may cause the first network node to receive, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time. The set of instructions, when executed by one or more processors of the first network node, may cause the first network node to transmit, to a second network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and wherein the second channel information is indicative of one or more channel characteristics corresponding to a second channel between the first network node and the electromagnetic radiation reflection relay network node.

Some aspects described herein relate to an apparatus for wireless communication. The apparatus may include means for receiving a signal comprising a first signal characteristic associated with a first pre-coding vector corresponding to a first communication channel between the apparatus and a first network node and a second signal characteristic associated with a second pre-coding vector corresponding to a second communication channel between the apparatus and an electromagnetic radiation reflection relay network node. The apparatus may include means for transmitting channel estimation information corresponding to the signal, wherein the channel estimation information includes first channel estimation information and second channel estimation information, wherein the first channel estimation information corresponds to the first communication channel and is based on the first pre-coding vector, and wherein the second channel estimation information corresponds to the second communication channel and is based on a second pre-coding vector associated with the second communication channel.

Some aspects described herein relate to an apparatus for wireless communication. The apparatus may include means for transmitting CLI configuration information that includes first information indicative of a reference signal resource. The apparatus may include means for receiving channel estimation information corresponding to a signal that is based on the reference signal resource, wherein the channel estimation information includes first channel estimation information and second channel estimation information, wherein the first channel estimation information corresponds to a first communication channel between a first network node and a second network node and is based on a first pre-coding vector associated with the first communication channel, and wherein the second channel estimation information corresponds to a second communication channel between an electromagnetic radiation reflection relay network node and the second network node and is based on a second pre-coding vector associated with the second communication channel. The apparatus may include means for transmitting reflection relay configuration information to the electromagnetic radiation reflection relay network node, wherein the reflection relay configuration information is indicative of one or more electromagnetic reflection parameters based on the channel estimation information.

Some aspects described herein relate to an apparatus for wireless communication. The apparatus may include means for receiving, from an aggressor network node, a plurality of aggressor reference signals, wherein the plurality of aggressor reference signals includes a first aggressor reference signal pre-coded by first pre-coding information and a second aggressor reference signal pre-coded by second pre-coding information. The apparatus may include means for receiving, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time. The apparatus may include means for transmitting, to a first network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the apparatus and the aggressor network node, and wherein the second channel information is indicative of one or more channel characteristics corresponding to a second channel between the apparatus and the electromagnetic radiation reflection relay network node.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment, in accordance with the present disclosure.

FIG. 2 is a diagram illustrating example components of an apparatus, in accordance with the present disclosure.

FIG. 3 is a diagram illustrating an example of a wireless network, in accordance with the present disclosure.

FIG. 4 is a diagram illustrating an environment including a network node in wireless communication with another network node, in accordance with the present disclosure.

FIG. 5 is a diagram illustrating an example of an open-radio access network architecture, in accordance with the present disclosure.

FIG. 6 is a diagram illustrating an example of wireless communication, in accordance with the present disclosure.

FIG. 7 is a diagram illustrating an example associated with reporting cross-link interference (CLI) associated with an electromagnetic radiation reflection relay service, in accordance with the present disclosure.

FIGS. 8-10 are diagrams illustrating example processes associated with reporting CLI associated with an electromagnetic radiation reflection relay service, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

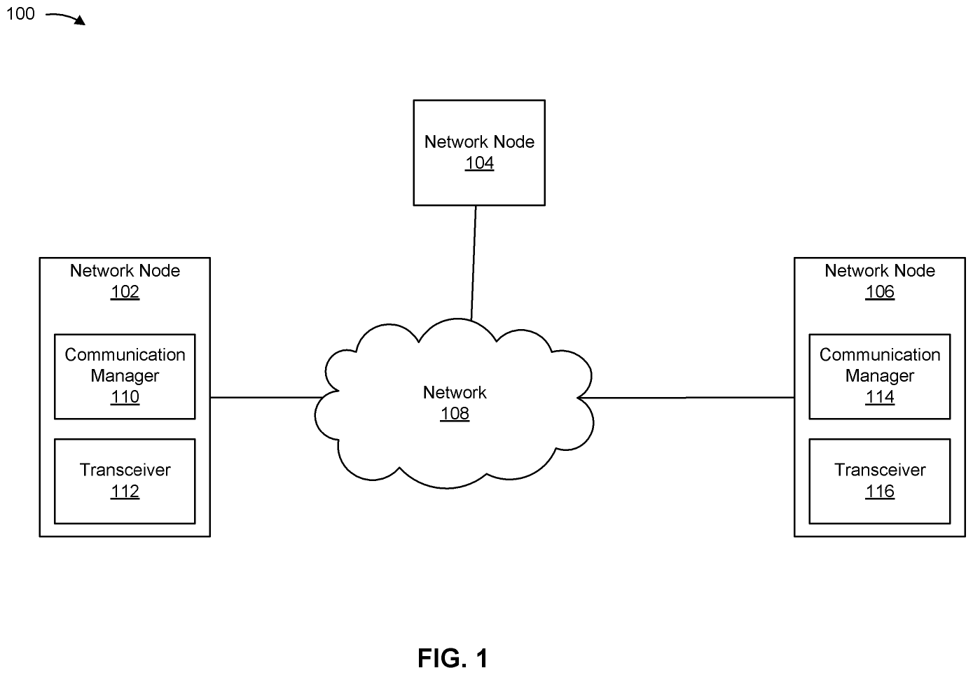

FIG. 1 is a diagram illustrating an example environment 100 in which apparatuses and/or methods described herein may be implemented, in accordance with the present disclosure. As shown in FIG. 1, the environment 100 may include a network node 102, a network node 104, and a network node 106 that may communicate with one another via a network 108. The network nodes 102, 104, and 106 may be dispersed throughout the network 108, and each network node 102, 104, and 106 may be stationary and/or mobile. The network 108 may include wired communication connections, wireless communication connections, or a combination of wired and wireless communication connections.

The network 108 may include, for example, a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

In general, any number of networks 108 may be deployed in a given geographic area. Each network 108 may support a particular radio access technology (RAT) and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, Open-RAT, New Radio (NR) or 5G RAT networks may be deployed.

In some aspects, the environment 100 may include one or more non-terrestrial network (NTN) deployments in which a non-terrestrial wireless communication device may include a network node. The network node may include a UE (which may be referred to herein, interchangeably, as a “non-terrestrial UE”), a base station (referred to herein, interchangeably, as a “non-terrestrial BS” and “non-terrestrial base station”), and/or a relay station (referred to herein, interchangeably, as a “non-terrestrial relay station”), among other examples. As used herein, “NTN” may refer to a network for which access is facilitated by a non-terrestrial UE, non-terrestrial base station, and/or a non-terrestrial relay station, among other examples.

One or more of the network nodes 102, 104, and 106 may be, include, of be included in any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. Satellites may communicate directly and/or indirectly with other entities in the environment using satellite communication. The other entities may include UEs (e.g., terrestrial UEs and/or non-terrestrial UEs), other satellites in the one or more NTN deployments, other types of base stations (e.g., stationary and/or ground-based BSs), relay stations, and/or one or more components and/or devices included in a core network, among other examples.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node

As shown, the network node 102 may include a communication manager 110 and a transceiver 112. The communication manager 110 may be configured to perform one or more communication tasks as described herein. In some aspects, the communication manager 110 may direct the transceiver 112 to perform one or more communication tasks as described herein. Similarly, the network node 106 may include a communication manager 114 and a transceiver 116. The communication manager 114 may be configured to perform one or more communication tasks as described herein. In some aspects, the communication manager 114 may direct the transceiver 116 to perform one or more communication tasks as described herein.

In some aspects, a first network node may include a communication manager 110 or a communication manager 114. As described in more detail elsewhere herein, the communication manager 110 or 114 may receive a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node; and transmit channel estimation information corresponding to the signal, wherein the channel estimation information includes first channel estimation information and second channel estimation information, wherein the first channel estimation information corresponds to the first communication channel and is based on the first pre-coding vector, and wherein the second channel estimation information corresponds to the second communication channel and is based on a second pre-coding vector associated with the second communication channel.

As described in more detail elsewhere herein, the communication manager 110 or 114 may transmit cross-link interference (CLI) configuration information that includes first information indicative of a reference signal resource; receive channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and wherein the second channel estimation information corresponds to a second communication channel between an electromagnetic radiation reflection relay network node and the third network node and is based on a second pre-coding vector associated with the second communication channel; and transmit reflection relay configuration information to the electromagnetic radiation reflection relay network node, wherein the reflection relay configuration information is indicative of one or more electromagnetic reflection parameters based on the channel estimation information.

As described in more detail elsewhere herein, the communication manager 110 or 114 may receive, from an aggressor network node, a plurality of aggressor reference signals, wherein the plurality of aggressor reference signals includes a first aggressor reference signal pre-coded by first pre-coding information and a second aggressor reference signal pre-coded by second pre-coding information; receive, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time; and transmit, to a second network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and wherein the second channel information is indicative of one or more channel characteristics corresponding to a second channel between the first network node and the electromagnetic radiation reflection relay network node. Additionally, or alternatively, the communication manager 110 and/or 114 may perform one or more other operations described herein.

The number and arrangement of entities shown in FIG. 1 are provided as one or more examples. In practice, there may be additional network nodes and/or networks, fewer network nodes and/or networks, different network nodes and/or networks, or differently arranged network nodes and/or networks than those shown in FIG. 1. Furthermore, the network node 102, 104, and/or 106 may be implemented using a single apparatus or multiple apparatuses.

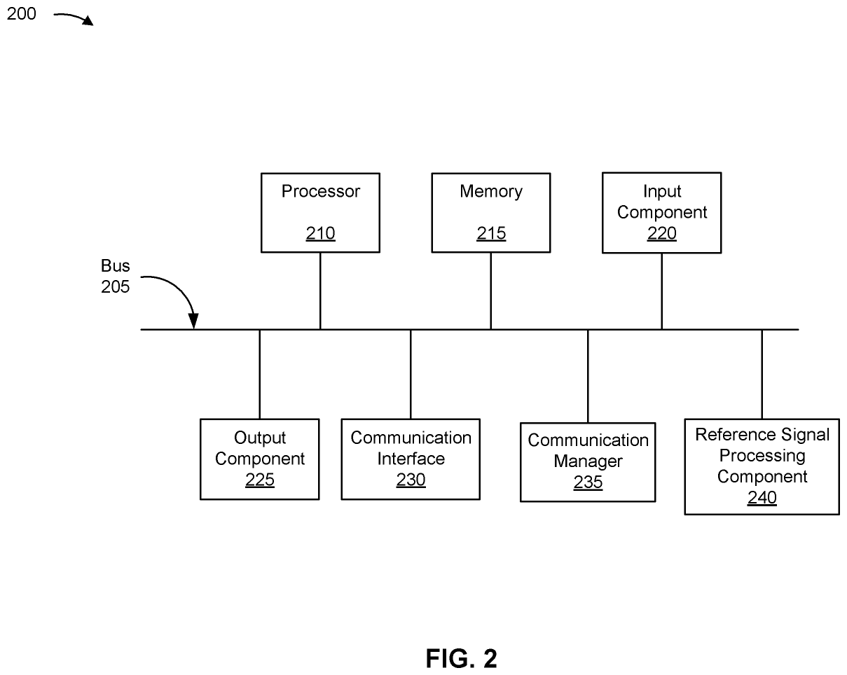

FIG. 2 is a diagram of example components of an apparatus 200. The apparatus 200 may correspond to the network node 102 and/or the network node 106. Additionally, or alternatively, the network node 102 and/or the network node 106 may include one or more apparatuses 200 and/or one or more components of the apparatus 200. For example, in some aspects, the apparatus 200 may include an apparatus (e.g., a device, a device component, a modem, a chip, and/or a set of device components, among other examples) that is configured to perform a wireless communication method at a network node, as described herein. As shown in FIG. 2, the apparatus 200 may include components such as a bus 205, a processor 210, a memory 215, an input component 220, an output component 225, a communication interface 230, a communication manager 235, and a reference signal processing component 240. Any one or more of the components 205, 210, 215, 220, 225 230, 235, and/or 240 may be implemented in hardware, software, or a combination of hardware and software.

The bus 205 includes a component that permits communication among the components of the apparatus 200. The processor 210 includes a central processing unit (CPU), a graphics processing unit (GPU), an accelerated processing unit (APU), a digital signal processor (DSP), a microprocessor, a microcontroller, a field-programmable gate array (FPGA), an application-specific integrated circuit (ASIC), and/or another type of processing component. In some aspects, the processor 210 includes one or more processors capable of being programmed to perform a function.

The memory 215 includes a random-access memory (RAM), a read only memory (ROM), and/or another type of dynamic or static storage device (e.g., a flash memory, a magnetic memory, and/or an optical memory) that stores information and/or instructions for use by the processor 210. The memory 215 may store other information and/or software related to the operation and use of the apparatus 200. For example, the memory 215 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium.

The input component 220 includes a component that permits the apparatus 200 to receive information, such as via user input. For example, the input component 220 may be associated with a user interface as described herein (e.g., to permit a user to interact with the one or more features of the apparatus 200). The input component 220 may include a capacitive touchscreen display that can receive user inputs. The input component 220 may include a keyboard, a keypad, a mouse, a button, a switch, and/or a microphone, among other examples. Additionally, or alternatively, the input component 220 may include a sensor for sensing information (e.g., a vision sensor, a location sensor, an accelerometer, a gyroscope, and/or an actuator, among other examples). In some aspects, the input component 220 may include a camera (e.g., a high-resolution camera and/or a low-resolution camera, among other examples). The output component 225 may include a component that provides output from the apparatus 200 (e.g., a display, a speaker, and/or one or more light-emitting diodes (LEDs), among other examples).

The communication interface 230 may include a transmission component and/or a reception component. For example, the communication interface 230 may include a transceiver and/or one or more separate receivers and/or transmitters that enable the apparatus 200 to communicate with other devices, such as via a wired connection, a wireless connection, or a combination of wired and wireless connections. In some aspects, the communication interface may include one or more radio frequency reflective elements and/or one or more radio frequency refractive elements. The communication interface 230 may permit the apparatus 200 to receive information from another apparatus and/or provide information to another apparatus. For example, the communication interface 230 may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

The communication manager 235 may include hardware, software, or a combination of hardware and software configured to cause the apparatus 200 to perform one or more communication tasks associated with the communication manager 110, the transceiver 112, the communication manager 114, and/or the transceiver 116. In some aspects, the communication manager 235 may be, be similar to, include, or be included in, the communication manager 110 and/or the communication manager 114 depicted in FIG. 1. In some aspects, the communication manager 235 may include the processor 210, the memory 215, the input component 220, the output component 225, the communication interface 230, and/or the reference signal processing component 240, and/or one or more aspects thereof.

As indicated above, FIG. 2 is provided as an example. Other examples may differ from what is described with regard to FIG. 2.

As described above, in some aspects, the network 108 depicted in FIG. 1 may include a cellular network that includes a RAT. While some aspects may be described herein using terminology commonly associated with a 5G or NR RAT, aspects of the present disclosure can be applied to other RATs, such as a 3G RAT, a 4G RAT, and/or a RAT subsequent to 5G (e.g., 6G).

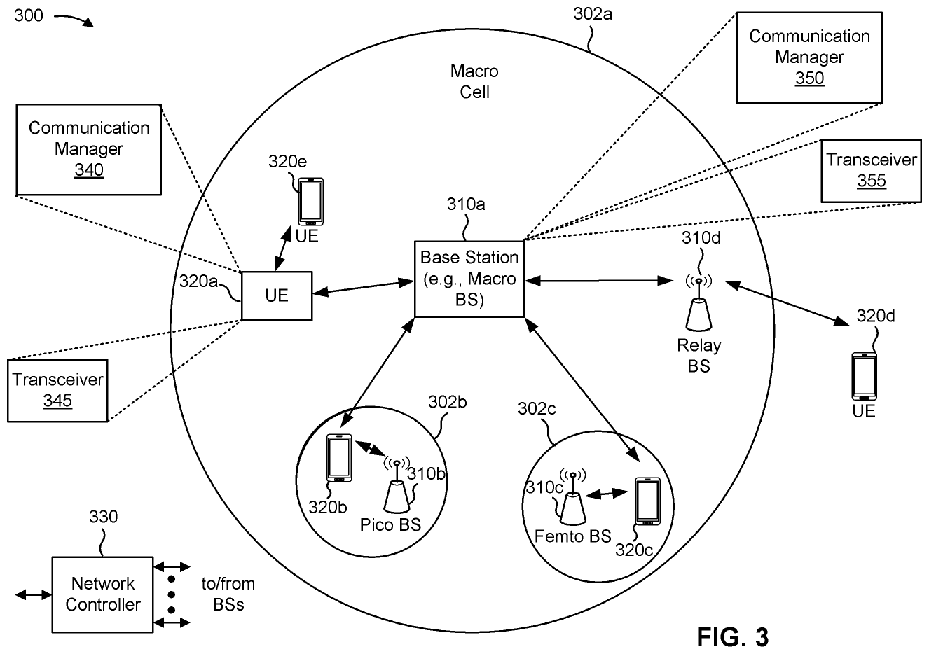

FIG. 3 is a diagram illustrating an example of a wireless network 300, in accordance with the present disclosure. The wireless network 300 may be or may include elements of a 4G (e.g., LTE) network, a 5G (e.g., NR) network, and/or a 6G network, among other examples. The wireless network 300 may include one or more base stations 310 (illustrated individually as a BS 310a, a BS 310b, a BS 310c, and a BS 310d), a UE 320 or multiple UEs 320 (illustrated individually as a UE 320a, a UE 320b, a UE 320c, a UE 320d, and a UE 320e), and/or other network entities. A base station 310 is an entity that communicates with UEs 320. A base station 310 may include, for example, an NR base station, an LTE base station, a Node B, an eNB (e.g., in 4G), a gNB (e.g., in 5G), an access point, and/or a transmission reception point (TRP). Each base station 310 may provide communication coverage for a particular geographic area. In the Third Generation Partnership Project (3GPP), the term “cell” can refer to a coverage area of a base station 310 and/or a base station subsystem serving the coverage area, depending on the context in which the term is used.

A base station 310 may provide communication coverage for a macro cell, a pico cell, a femto cell, and/or another type of cell. A macro cell may cover a relatively large geographic area (e.g., several kilometers in radius) and may allow unrestricted access by UEs 320 with service subscriptions. A pico cell may cover a relatively small geographic area and may allow unrestricted access by UEs 320 with service subscription. A femto cell may cover a relatively small geographic area (e.g., a home) and may allow restricted access by UEs 320 having association with the femto cell (e.g., UEs 320 in a closed subscriber group (CSG)). A base station 310 for a macro cell may be referred to as a macro base station. A base station 310 for a pico cell may be referred to as a pico base station. A base station 310 for a femto cell may be referred to as a femto base station or an in-home base station. In the example shown in FIG. 3, the BS 310a may be a macro base station for a macro cell 302a, the BS 310b may be a pico base station for a pico cell 302b, and the BS 310c may be a femto base station for a femto cell 302c. A base station may support one or multiple (e.g., three) cells.

In some examples, a cell may not necessarily be stationary, and the geographic area of the cell may move according to the location of a base station 310 that is mobile (e.g., a mobile base station). In some examples, the base stations 310 may be interconnected to one another and/or to one or more other base stations 310 or network nodes (not shown) in the wireless network 300 through various types of backhaul interfaces, such as a direct physical connection or a virtual network, using any suitable transport network.

The wireless network 300 may include one or more relay stations. A relay station is an entity that can receive a transmission of data from an upstream station (e.g., a base station 310 or a UE 320) and send a transmission of the data to a downstream station (e.g., a UE 320 or a base station 310). A relay station may be a UE 320 that can relay transmissions for other UEs 320. In the example shown in FIG. 3, the BS 310d (e.g., a relay base station) may communicate with the BS 310a (e.g., a macro base station) and the UE 320d in order to facilitate communication between the BS 310a and the UE 320d. A base station 310 that relays communications may be referred to as a relay station, a relay base station, a relay, or the like.

The wireless network 300 may be a heterogeneous network that includes base stations 310 of different types, such as macro base stations, pico base stations, femto base stations, relay base stations, or the like. These different types of base stations 310 may have different transmit power levels, different coverage areas, and/or different impacts on interference in the wireless network 300. For example, macro base stations may have a high transmit power level (e.g., 5 to 40 watts) whereas pico base stations, femto base stations, and relay base stations may have lower transmit power levels (e.g., 0.1 to 2 watts).

A network controller 330 may couple to or communicate with a set of base stations 310 and may provide coordination and control for these base stations 310. The network controller 330 may communicate with the base stations 310 via a backhaul communication link. The base stations 310 may communicate with one another directly or indirectly via a wireless or wireline backhaul communication link. For example, in some aspects, the wireless network 300 may be, include, or be included in a wireless backhaul network, sometimes referred to as an IAB network. In an IAB network, at least one base station (e.g., base station 310) may be an anchor base station that communicates with a core network via a wired backhaul link, such as a fiber connection. An anchor base station may also be referred to as an IAB donor (or IAB-donor), a central entity, a central unit, and/or the like. An IAB network may include one or more non-anchor base stations, sometimes referred to as relay base stations or IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 320) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target wireless node (e.g., a UE and/or a base station). In this way, inter-link interference may be reduced.

An IAB network may include an IAB donor that connects to a core network via a wired connection (e.g., a wireline backhaul). For example, an Ng interface of an IAB donor may terminate at a core network. Additionally, or alternatively, an IAB donor may connect to one or more devices of the core network that provide a core access and mobility management function (AMF). In some aspects, an IAB donor may include a base station 310, such as an anchor base station. An IAB donor may include a central unit, which may perform access node controller (ANC) functions and/or AMF functions. The central unit may configure a DU of the IAB donor and/or may configure one or more IAB nodes (e.g., a mobile termination (MT) function and/or a DU function of an IAB node) that connect to the core network via the IAB donor. Thus, a central unit of an IAB donor may control and/or configure the entire IAB network (or a portion thereof) that connects to the core network via the IAB donor, such as by using control messages and/or configuration messages (e.g., a radio resource control (RRC) configuration message or an F1 application protocol (F1AP) message).

The MT functions of an IAB node (e.g., a child node) may be controlled and/or scheduled by another IAB node (e.g., a parent node of the child node) and/or by an IAB donor. The DU functions of an IAB node (e.g., a parent node) may control and/or schedule other IAB nodes (e.g., child nodes of the parent node) and/or UEs 320. Thus, a DU may be referred to as a scheduling node or a scheduling component, and an MT may be referred to as a scheduled node or a scheduled component. In some aspects, an IAB donor may include DU functions and not MT functions. That is, an IAB donor may configure, control, and/or schedule communications of IAB nodes and/or UEs 320. A UE 320 may include only MT functions, and not DU functions. That is, communications of a UE 320 may be controlled and/or scheduled by an IAB donor and/or an IAB node (e.g., a parent node of the UE 320).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor or an IAB node, and a child node may be an IAB node or a UE 320. Communications of an MT function of a child node may be controlled and/or scheduled by a parent node of the child node.

A link between a UE 320 and an IAB donor, or between a UE 320 and an IAB node, may be referred to as an access link. An access link may be a wireless access link that provides a UE 320 with radio access to a core network via an IAB donor, and optionally via one or more IAB nodes. Thus, the wireless network 300 may be referred to as a multi-hop network or a wireless multi-hop network.

A link between an IAB donor and an IAB node or between two IAB nodes may be referred to as a backhaul link. A backhaul link may be a wireless backhaul link that provides an IAB node with radio access to a core network via an IAB donor, and optionally via one or more other IAB nodes. In an IAB network, network resources for wireless communications (e.g., time resources, frequency resources, and/or spatial resources) may be shared between access links and backhaul links. In some aspects, a backhaul link may be a primary backhaul link or a secondary backhaul link (e.g., a backup backhaul link). In some aspects, a secondary backhaul link may be used if a primary backhaul link fails, becomes congested, and/or becomes overloaded, among other examples.

The UEs 320 may be dispersed throughout the wireless network 300, and each UE 320 may be stationary or mobile. A UE 320 may include, for example, an access terminal, a terminal, a mobile station, and/or a subscriber unit. A UE 320 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 320 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 320 may be considered Internet-of-Things (IoT) devices, and/or may be implemented as NB-IoT (narrowband IoT) devices. Some UEs 320 may be considered a customer premises equipment. A UE 320 may be included inside a housing that houses components of the UE 320, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 300 may be deployed in a given geographic area. Each wireless network 300 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 320 (e.g., shown as UE 320a and UE 320e) may communicate directly using one or more sidelink channels (e.g., without using a base station 310 as an intermediary to communicate with one another). For example, the UEs 320 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 320 may perform scheduling operations, resource selection operations, and/or other operations described elsewhere herein as being performed by the base station 310.

Devices of the wireless network 300 may communicate using the electromagnetic spectrum, which may be subdivided by frequency or wavelength into various classes, bands, channels, or the like. For example, devices of the wireless network 300 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described above, in some aspects, a network node (e.g., the network node 102, 104, and/or the network node 106 depicted in FIG. 1) may be implemented in a wireless communication environment. For example, in some aspects, the network node may be implemented as a UE (e.g., UE 320a) a base station (e.g., base station 310a), relay device, and/or TRP, among other examples. In some such aspects, as shown in FIG. 3, the UE 320a may include a communication manager 340 and/or a transceiver 345 and the base station 310a may include a communication manager 350 and/or a transceiver 355. In some aspects, the communication manager 340 and/or 350 may be, be similar to, include, or be included in, the communication manager 110 and/or 114 depicted in FIG. 1 and/or the communication manager 235 depicted in FIG. 2. In some aspects, the transceiver 345 and/or 355 may be, be similar to, include, or be included in, the transceiver 112 and/or 116 depicted in FIG. 1. In some aspects, the transceiver 345 and/or 355 may include, or be included in, the communication interface 230 depicted in FIG. 2.

As indicated above, FIG. 3 is provided as an example. Other examples may differ from what is described with regard to FIG. 3.

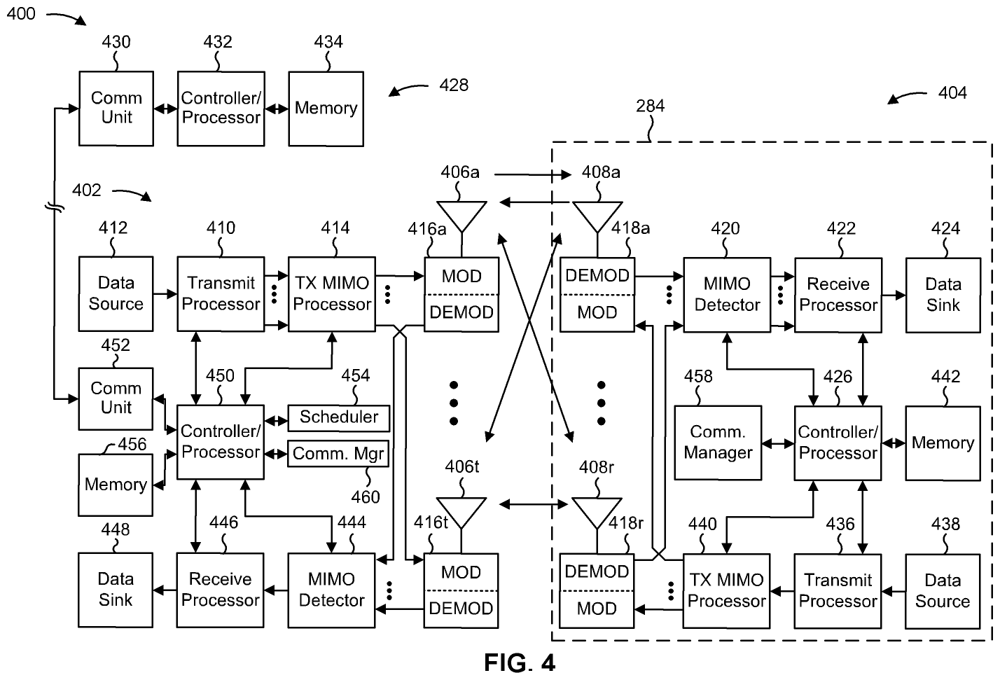

FIG. 4 is a diagram illustrating an environment 400 including a network node 402 in wireless communication with a network node 404 (e.g., via a network such as the network 108 depicted in FIG. 1 and/or the wireless network 300 depicted in FIG. 3), in accordance with the present disclosure. The network node 402 may be equipped with a set of antennas 406a through 406t, such as T antennas (T≥1). The network node 404 may be equipped with a set of antennas 408a through 408r, such as R antennas (R≥1).

At the network node 402, a transmit processor 410 may receive data, from a data source 412, intended for the network node 404 (or a set of network nodes 404). The transmit processor 410 may select one or more modulation and coding schemes (MCSs) for the network node 404 based on one or more channel quality indicators (CQIs) received from that network node 404. The network node 402 may process (e.g., encode and modulate) the data for the network node 404 based on the MCS(s) selected for the network node 404 and may provide data symbols for the network node 404. The transmit processor 410 may process system information (e.g., for semi-static resource partitioning information (SRPI)) and control information (e.g., CQI requests, grants, and/or upper layer signaling) and provide overhead symbols and control symbols. The transmit processor 410 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 414 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 416a through 416t (e.g., T modems). For example, each output symbol stream may be provided to a modulator component (shown as MOD) of a modem of the set of modems 416a through 416t. Each modem of the set of modems 416a through 416t may use a respective modulator component to process a respective output symbol stream (e.g., for OFDM) to obtain an output sample stream. Each modem of the set of modems 416a through 416t may further use a respective modulator component to process (e.g., convert to analog, amplify, filter, and/or upconvert) the output sample stream to obtain a signal. One or more modems of the set of modems 416a through 416t may transmit a set of signals (e.g., T signals) via a corresponding antenna of the set of antennas 406a through 406t. The signal may include, for example, a downlink signal.

At the network node 404, one or more antennas of the set of antennas 408a through 408r may receive the signals from the network node 402 and/or network nodes and may provide a set of received signals (e.g., R received signals) to one or more modems of a set of modems 418a through 418r (e.g., R modems). For example, each received signal may be provided to a demodulator component (shown as DEMOD) of a respective modem of the set of modems 418a through 418r. Each modem of the set of modems 418a through 418r may use a respective demodulator component to condition (e.g., filter, amplify, downconvert, and/or digitize) a received signal to obtain input samples. Each modem of the set of modems 418a through 418r may use a demodulator component to further process the input samples (e.g., for OFDM) to obtain received symbols. A MIMO detector 420 may obtain received symbols from one or more modems of the set of modems 418a through 418r, may perform MIMO detection on the received symbols if applicable, and may provide detected symbols.

A receive processor 422 may process (e.g., demodulate and decode) the detected symbols, may provide decoded data for the network node 404 to a data sink 424, and may provide decoded control information and system information to a controller/processor 426. The term “controller/processor” may refer to one or more controllers, one or more processors, or a combination thereof. The controller/processor 426 may be, be similar to, include, or be included in, the processor 210 depicted in FIG. 2. The controller/processor 426 may determine a reference signal received power (RSRP) parameter, a received signal strength indicator (RSSI) parameter, a reference signal received quality (RSRQ) parameter, and/or a CQI parameter, among other examples.

A network controller 428 may include a communication unit 430, a controller/processor 432, and a memory 434. The network controller 428 may be, be similar to, include, or be included in, the network controller 330 depicted in FIG. 3. The network controller 428 may include, for example, one or more devices in a core network. The network controller 428 may communicate with the network node 402 via the communication unit 430.

One or more antennas (e.g., antennas 406a through 406t and/or antennas 408a through 408r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 4.

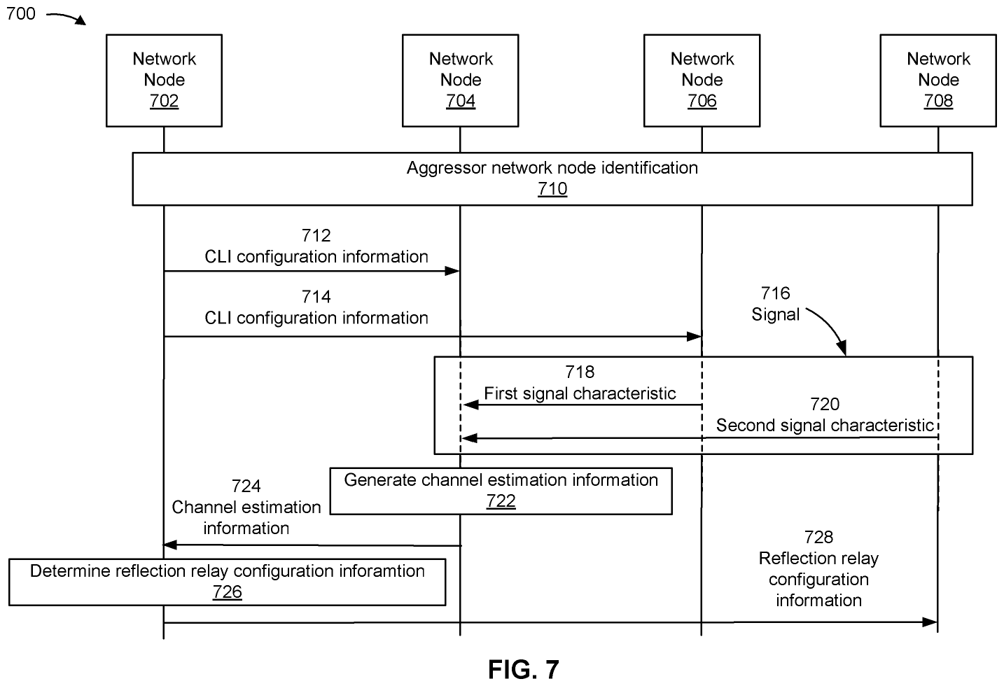

Similarly, at the network node 404, a transmit processor 436 may receive and process data from a data source 438 and control information (e.g., for reports that include RSRP, RSSI, RSRQ, and/or CQI) from the controller/processor 426. The transmit processor 436 may generate reference symbols for one or more reference signals. The symbols from the transmit processor 436 may be precoded by a TX MIMO processor 440 if applicable, and further processed by one or more of the set of modems 418a through 418r (e.g., for DFT-s-OFDM or CP-OFDM), and transmitted to the network node 402. In some examples, each modem of the set of modems 418a through 418r of the network node 404 may include a modulator and a demodulator. In some examples, the network node 404 includes a transceiver. The transceiver may include any combination of the antenna(s) 408a through 408r, the modem(s) 418a through 418r, the MIMO detector 420, the receive processor 422, the transmit processor 436, and/or the TX MIMO processor 440. The transceiver may be, be similar to, include, or be included in, the communication interface 230 depicted in FIG. 2. The transceiver may be used by a processor (e.g., the controller/processor 426) and/or a memory 442 to perform aspects of any of the methods described herein (e.g., with reference to FIGS. 7-11).

At the network node 402, the signals from network node 404 and/or other network nodes may be received by one or more antennas of the set of antennas 406a through 406t, processed by one or more modems of the set of modems 416a through 416t (e.g., a demodulator component, shown as DEMOD), detected by a MIMO detector 444 if applicable, and further processed by a receive processor 446 to obtain decoded data and control information sent by the network node 404. The receive processor 446 may provide the decoded data to a data sink 448 and provide the decoded control information to a controller/processor 450. The network node 402 may include a communication unit 452 and may communicate with the network controller 428 via the communication unit 452. The network node 402 may include a scheduler 454 to schedule one or more network nodes 404 for downlink and/or uplink communications. In some examples, one or more modems of the set of modem 416a through 416t of the network node 402 may include a modulator and a demodulator. In some examples, the network node 402 includes a transceiver. The transceiver may include any combination of the antenna(s) 406a through 406t, the modem(s) 416a through 416t, the MIMO detector 444, the receive processor 446, the transmit processor 410, and/or the TX MIMO processor 414. The transceiver may be, be similar to, include, or be included in, the communication interface 230 depicted in FIG. 2. The transceiver may be used by a processor (e.g., the controller/processor 450) and a memory 456 to perform aspects of any of the methods described herein (e.g., with reference to FIGS. 7-11).

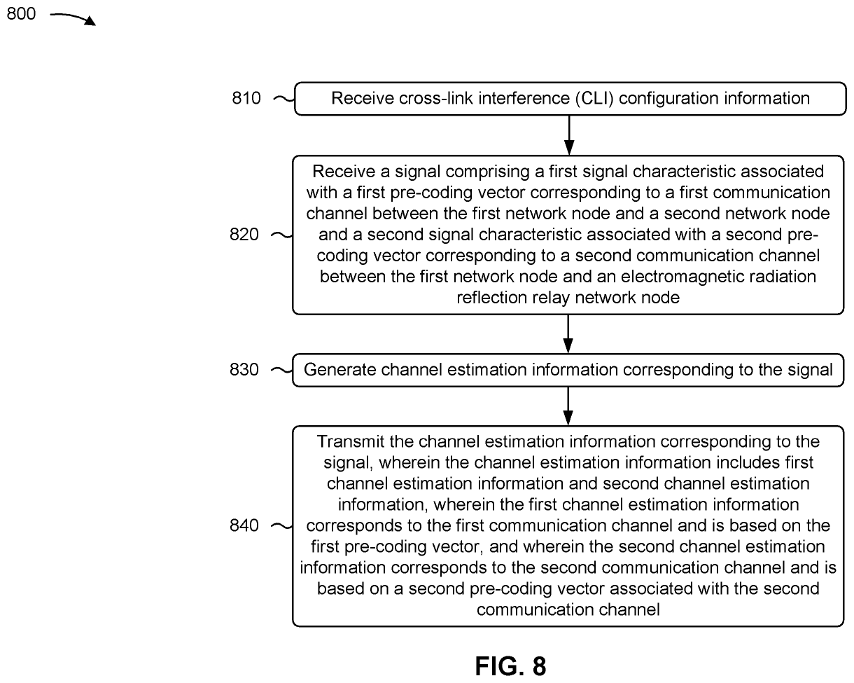

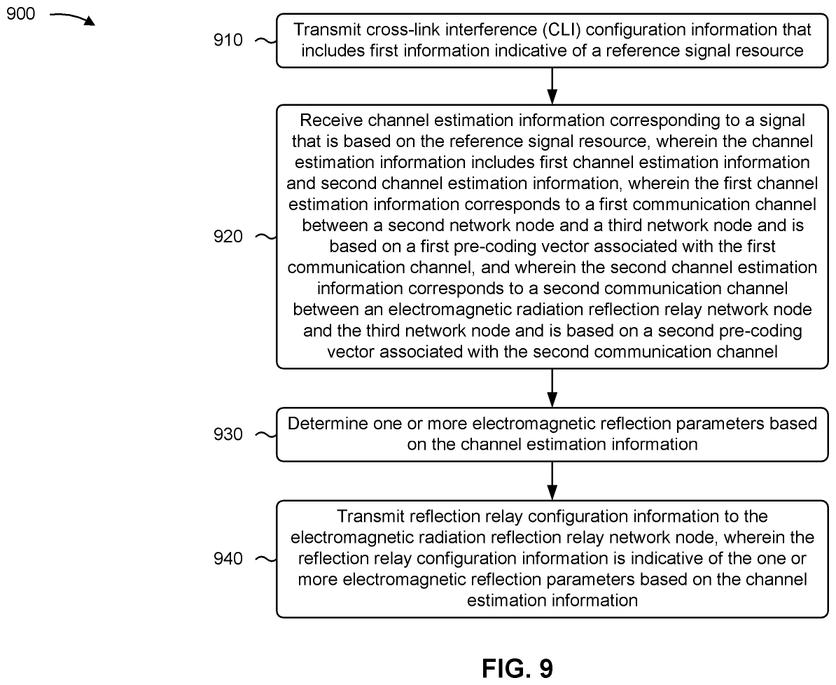

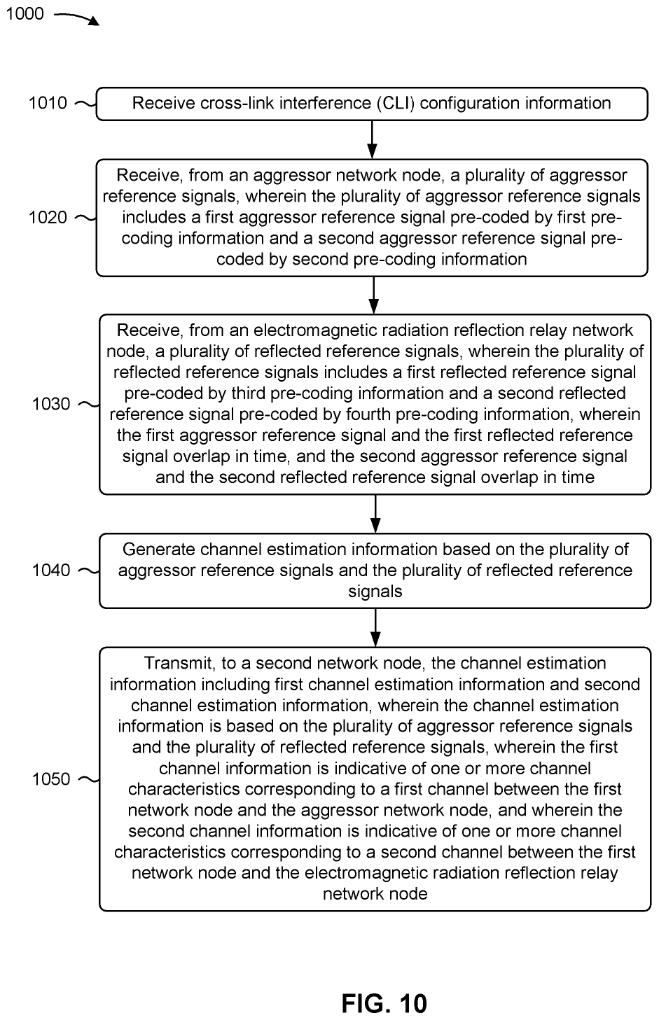

The controller/processor 450 of the network node 402, the controller/processor 426 of the network node 404, and/or any other component(s) of FIG. 4 may perform one or more techniques associated with reporting CLI associated with an electromagnetic radiation reflection relay service, as described in more detail elsewhere herein. For example, the controller/processor 450 of the network node 402, the controller/processor 426 of the network node 404, and/or any other component(s) of FIG. 4 may perform or direct operations of, for example, process 800 of FIG. 8, process 900 of FIG. 9, process 1000 of FIG. 10, and/or other processes as described herein. The memory 442 and the memory 456 may store data and program codes for the network node 402 and the network node 404, respectively. In some examples, the memory 442 and/or the memory 456 may include a non-transitory computer-readable medium storing one or more instructions (e.g., code and/or program code) for wireless communication. For example, the one or more instructions, when executed (e.g., directly, or after compiling, converting, and/or interpreting) by one or more respective processors of the network node 402 and/or the network node 404, may cause the one or more processors, the network node 404, and/or the network node 402 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a first network node includes means for receiving a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node; and/or means for transmitting channel estimation information corresponding to the signal, wherein the channel estimation information includes first channel estimation information and second channel estimation information, wherein the first channel estimation information corresponds to the first communication channel and is based on the first pre-coding vector, and the second channel estimation information corresponds to the second communication channel and is based on a second pre-coding vector associated with the second communication channel.

In some aspects, the first network node includes means for transmitting CLI configuration information that includes first information indicative of a reference signal resource; means for receiving channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and the second channel estimation information corresponds to a second communication channel between an electromagnetic radiation reflection relay network node and the third network node and is based on a second pre-coding vector associated with the second communication channel; and/or means for transmitting reflection relay configuration information to the electromagnetic radiation reflection relay network node, wherein the reflection relay configuration information is indicative of one or more electromagnetic reflection parameters based on the channel estimation information.

In some aspects, the first network node includes means for receiving, from an aggressor network node, a plurality of aggressor reference signals, wherein the plurality of aggressor reference signals includes a first aggressor reference signal pre-coded by first pre-coding information and a second aggressor reference signal pre-coded by second pre-coding information; means for receiving, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time; and/or means for transmitting, to a second network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and wherein the second channel information is indicative of one or more channel characteristics corresponding to a second channel between the first network node and the electromagnetic radiation reflection relay network node. In some aspects, the means for the network node to perform operations described herein may include, for example, one or more of communication manager 458 or 460, transmit processor 410 or 436, TX MIMO processor 414 or 440, modem 416a-416t or 418a-418r, antenna 406a-406t or 408a-408r, MIMO detector 420 or 444, receive processor 422 or 446, controller/processor 426 or 450, memory 442 or 456, or scheduler 454.

While blocks in FIG. 4 are illustrated as distinct components, the functions described above with respect to the blocks may be implemented in a single hardware, software, or combination component or in various combinations of components. For example, the functions described with respect to the transmit processor 436, the receive processor 422, and/or the TX MIMO processor 440 may be performed by or under the control of the controller/processor 426. Any number of other combination of various combinations of components depicted in FIG. 4 may be within the ambit of the present disclosure.

As indicated above, FIG. 4 is provided as an example. Other examples may differ from what is described with regard to FIG. 4.

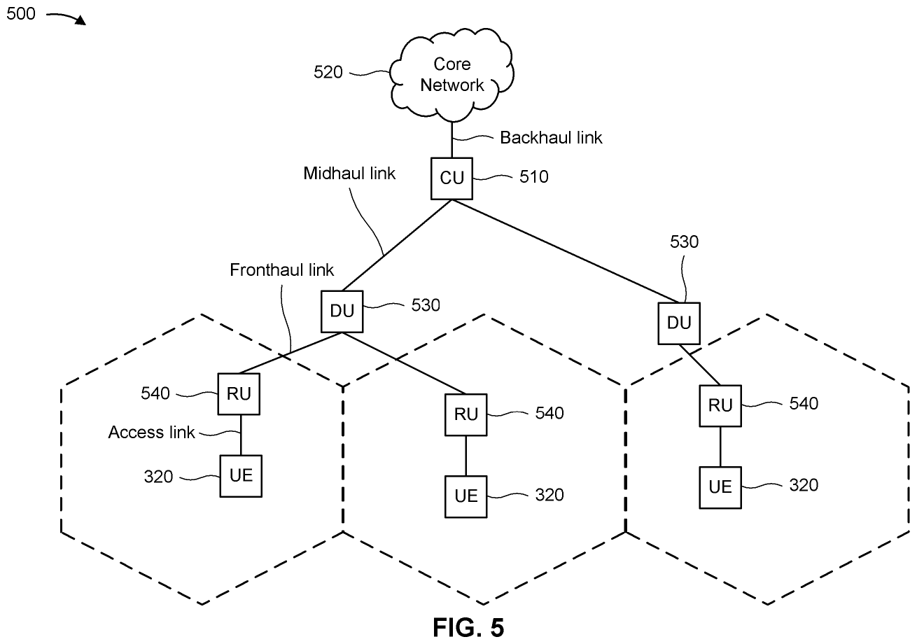

FIG. 5 is a diagram illustrating an example 500 of an O-RAN architecture, in accordance with the present disclosure. As shown in FIG. 5, the O-RAN architecture may include a CU 510 that communicates with a core network 520 via a backhaul link. Furthermore, the CU 510 may communicate with one or more DUs 530 via respective midhaul links. The DUs 530 may each communicate with one or more RUs 540 via respective fronthaul links, and the RUs 540 may each communicate with respective UEs 320 via RF access links. The DUs 530 and the RUs 540 may also be referred to as O-RAN DUS (O-DUs) 530 and O-RAN RUs (O-RUs) 540, respectively.

In some aspects, the DUs 530 and the RUs 540 may be implemented according to a functional split architecture in which functionality of a base station 310 (e.g., an eNB or a gNB) is provided by a DU 530 and one or more RUs 540 that communicate over a fronthaul link. Accordingly, as described herein, a base station 310 may include a DU 530 and one or more RUs 540 that may be co-located or geographically distributed. In some aspects, the DU 530 and the associated RU(s) 540 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 530 may correspond to a logical unit that includes one or more base station functions to control the operation of one or more RUs 540. For example, in some aspects, the DU 530 may host a radio link control (RLC) layer, a medium access control (MAC) layer, and one or more high physical (PHY) layers (e.g., forward error correction (FEC) encoding and decoding, scrambling, and/or modulation and demodulation) based on a lower layer functional split. Higher layer control functions, such as a packet data convergence protocol (PDCP), RRC, and/or service data adaptation protocol (SDAP), may be hosted by the CU 510. The RU(s) 540 controlled by a DU 530 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based on the lower layer functional split. Accordingly, in an O-RAN architecture, the RU(s) 540 handle all over the air (OTA) communication with a UE 320, and real-time and non-real-time aspects of control and user plane communication with the RU(s) 540 are controlled by the corresponding DU 530, which enables the DU(s) 530 and the CU 510 to be implemented in a cloud-based RAN architecture.

As indicated above, FIG. 5 is provided as an example. Other examples may differ from what is described with regard to FIG. 5.

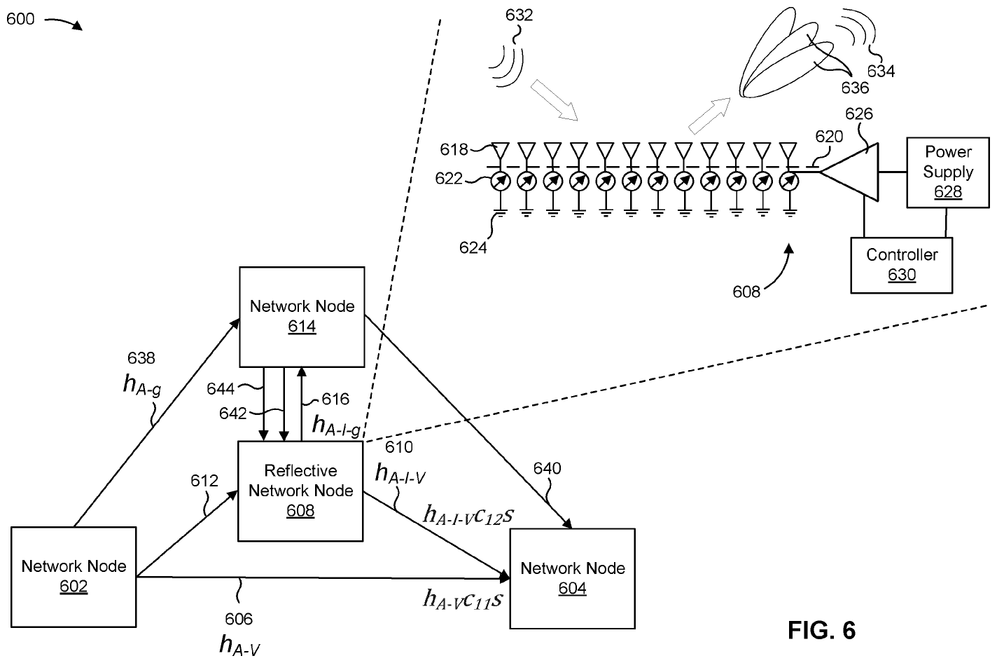

FIG. 6 is a diagram illustrating an example 600 of wireless communication, in accordance with the present disclosure. As shown, a first network node 602 and a second network node 604 can communicate via a communication channel 606. An electromagnetic radiation reflective relay network node 608 (shown as “reflective network node”) can be used to relay signals from the network node 602 to the network node 604 via a communication channel 610. The electromagnetic radiation reflective relay network node 608 can include, for example, a radio frequency reflection array configured to perform radio frequency reflection services. The electromagnetic radiation reflective relay network node 608 can be, for example, a reconfigurable intelligent surface (RIS) (which also can be referred to as an intelligent reflective surface (IRS)).

As shown, for example, the network node 602 can transmit a signal, via a communication channel 612, to the electromagnetic radiation reflective relay network node 608, which can relay the signal, via the communication channel 610, to the network node 604. In some cases, the electromagnetic radiation reflective relay network node 608 can relay transmissions between the network node 602 and a network node 614. For example, as shown, the network node 602 can transmit, via the communication channel 612, a signal to the electromagnetic radiation reflective relay network node 608, which can relay the signal, via a communication channel 616, to the network node 614.

As shown in FIG. 6, the electromagnetic radiation reflective relay network node 608 may include a set of reflecting elements 618 disposed adjacent to a ground plane 620. Each reflecting element 618 can be coupled to a phase shifting component 622, and each phase shifting component 622 can be coupled to a respective grounding component 624. In some aspects, each reflecting element 618 can be coupled to two phase shifting components 622, one for each polarization. In some aspects, one or more reflecting elements 618 can be driven by a power amplifier 626. The power amplifier 626 can be coupled to a power supply 628 and can be controlled by a controller 630. In some cases, for example, the power amplifier 626 can be configured to provide just enough power to offset energy loss due to reflection of a signal and/or phase adjustment thereof. In some cases, a complexity of the controller 630 and/or power consumption by the power amplifier 626 can be based on selection of phase shifting components 622. In some cases, the electromagnetic radiation reflective relay network node 608 can be configured to reflect a signal 632 (e.g., the signal transmitted via the communication channel 612) by beamforming a reflected signal 634 (e.g., the signal transmitted via the communication channel 616) to direct the reflected signal 634 based on one or more beams 636.

In some cases, as shown, the network node 602 can transmit, via a communication channel 638, a signal to the network node 614 without using the electromagnetic radiation reflective relay network node 608 as a relay. The network node 614 can transmit, via a communication channel 640, a signal to the network node 604. In some cases, the network node 614 can transmit, via a communication channel 642, a signal to the electromagnetic radiation reflective relay network node 608, which can relay, via the communication channel 610, the signal to the network node 604. In some cases, the network node 614 can transmit, via a communication channel 644, configuration information to the electromagnetic radiation reflective relay network node 608 to configure one or more aspects of the operation of the electromagnetic radiation reflective relay network node 608.

In a communication scenario such as the scenario depicted in FIG. 6, CLI may impede efficiency and accuracy of communications. CLI is the interference from one entity to another nearby entity. For example, CLI can occur between two network nodes, such as UEs, when a network configures different time domain duplexing (TDD) UL and DL slot formats to nearby UEs. When a network node (e.g., network node 602) (which may be referred to as an aggressor network node) is transmitting, another network node (e.g., network node 604), (which may be referred to as a victim network node) may receive this transmission as CLI in its DL symbols if the aggressor network node's UL symbol collide with at least one DL symbol of the victim network node. As shown in FIG. 6, the aggressor network node 602 can communicate with the network node 614 via the channel 638 (which can be indicated as “h_{A-g}”). The aggressor network node 602 can interfere with the victim network node 604 via CLI in the channel 606 (which may be indicated as “h_{A-V}”). In some cases, the electromagnetic radiation reflective relay network node 608 can be configured to maximize a channel strength of the channel 616 (which can be indicated as “h_{A-I-g}”). The aggressor network node 602 also may interfere with the victim network node 604 via CLI in the reflected channel 610 (which may be indicated as “h_{A-I-V}”). In some cases, the victim network node 604 can measure CLI from the aggressor network node 602. For example, the victim network node 604 can measure CLI if the network configures one or more CLI measurement resources to do so. CLI measurement is defined as periodic measurement based on sounding reference signal (SRS) RSRP or RSSI. The CLI can reduce the effectiveness of communications, thereby negatively impacting network performance.

Some techniques and apparatuses described herein provide for measurement of CLI associated with an electromagnetic radiation reflective relay network node and mitigation of CLI based on those measurements. For example, in some aspects, the network node 604 may receive a signal (which may be indicated as “y_{T1}”) that includes a first signal characteristic (which may be indicated as “h_{A-V}c₁₁s”) associated with a first pre-coding vector, c₁₁, corresponding to a first communication channel, h_{A-V}, (e.g., the communication channel 606) between the network node 604 and the network node 602 and a second signal characteristic (which may be indicated as h_{A-I-V}c₁₂s”) associated with a second pre-coding vector, c₁₂, corresponding to a second communication channel (e.g., the communication channel 610) between the network node 604 and the electromagnetic radiation reflection relay network node. The network node 604 may transmit, and the network node 614 may receive, channel estimation information corresponding to the signal. The channel estimation information may include first channel estimation information and second channel estimation information. The first channel estimation information corresponds to the first communication channel and is based on the first pre-coding vector, and the second channel estimation information corresponds to the second communication channel and is based on a second pre-coding vector.

In some aspects, the network node 614 may transmit reflection relay configuration information to the electromagnetic radiation reflection relay network node 608. The reflection relay configuration information may be indicative of one or more electromagnetic reflection parameters based on the channel estimation information. In some aspects, the electromagnetic radiation reflection relay network node 608 may be used to manipulate and/or add a signal propagation path for mitigating CLI impact. For example, in some aspects, reflection relay configuration information may be used to configure the electromagnetic radiation reflection relay network node 608 to increase, or maximize, a signal strength of signals transmitted via the communication channel 616, h_{A-I-g}. In some aspects, the reflection relay configuration information may be used to configure the electromagnetic radiation reflection relay network node 608 to reduce, or minimize, a signal strength of signals transmitted via the communication channel 616, h_{A-I-g}. In some aspects, the reflection relay configuration information may be used to configure the electromagnetic radiation reflection relay network node 608 to reduce, or minimize, CLI in the communication channel 606. For example, CLI in the communication channel 610 may nullify (e.g., cancel) all or part of the CLI in the communication channel 606. In this way, aspects described herein may provide for utilizing joint estimation of two channels based on one or more resources configured for CLI measurement associated with an electromagnetic radiation reflection relay network node to facilitate mitigation of CLI, thereby positively impacting network performance.

As indicated above, FIG. 6 is provided as an example. Other examples may differ from what is described with regard to FIG. 6.

FIG. 7 is a diagram illustrating an example 700 associated with nonlinear modeling for channel estimation, in accordance with the present disclosure. As shown, a network node 702, a network node 704, a network node 706, and a network node 708 may communicate with one another. The network nodes 702, 704, 706, and/or 708 may be, or be similar, to the network node 102 and/or the network node 104 depicted in FIG. 1. The network node 702 may be, or be similar to, the network node 614 depicted in FIG. 6. The network node 704 may be a victim network node and may be, or be similar to, the network node 604 depicted in FIG. 6. The network node 706 may be an aggressor network node and may be, or be similar to, the network node 602 depicted in FIG. 6. The network node 708 may be an electromagnetic radiation reflection relay network node and may be, or be similar to, the electromagnetic radiation reflection relay network node 608 depicted in FIG. 6.

As shown by reference number 710, the first network node 702, the second network node 704, the third network node 706, and/or the fourth network node 708 may perform an aggressor network node identification process to identify an aggressor network node. For example, in some aspects, the network node 702 may receive information from one or more of the network nodes 704, 706, and/or 708. The network node 702 may determine, based on the received information, that the network node 706 is an aggressor network node. In some aspects, the network node 704 may determine that the network node 702 is an aggressor network node.

As shown by reference number 712, the network node 702 may transmit, and the network node 704, may receive, CLI configuration information. Similarly, as shown by reference number 714, the network node 702 may transmit, and the network node 706 may receive, CLI configuration information. In some aspects, the CLI configuration information transmitted to the network node 704 may be the same as the CLI configuration information transmitted to the network node 706. In some other aspects, the CLI configuration information transmitted to the network node 704 may be at least partially different than the CLI configuration information transmitted to the network node 706. For example, the CLI configuration information may configure the network node 704 with CLI measurement resources and/or CLI measurement parameters that may be used by the network node 704 to measure CLI. The CLI configuration information may configure the network node 706 with pre-coding information, CLI reference signal resources (e.g., SRS resources), and/or CLI reference signal transmission parameters.

In some aspects, the CLI configuration information transmitted to the network node 704 may specify the network node 706 and the network node 708 (e.g., the electromagnetic radiation reflection relay network node). In some aspects, the CLI configuration information transmitted to the network node 704 and/or the network node 706 may include first information indicative of a reference signal resource. In some aspects, the CLI configuration information transmitted to the network node 704 and/or 706 may include second information indicative of a plurality of pre-coding vectors corresponding to a pre-coding matrix. The plurality of pre-coding vectors may include the first pre-coding vector and the second pre-coding vector. In some aspects, the plurality of pre-coding vectors may include at least one additional pre-coding vector associated with at least one additional network node configured to provide at least one additional electromagnetic radiation reflection relay service. In some aspects, the network node 704 may include a memory that includes non-signaled information stored thereon, where the non-signaled information includes the first pre-coding vector and the second pre-coding vector.

As shown by reference number 716, the network node 704 may receive a signal. In some aspects, the signal may include a reference signal such as, for example, an SRS. In some aspects, the signal may include a first signal characteristic 718 associated with a first pre-coding vector corresponding to a first communication channel between the network node 704 and the network node 702. In some aspects, the first signal characteristic may be referred to as a first “aggressor reference signal,” and may be pre-coded by first pre-coding information (e.g., the first pre-coding vector). For example, the first signal characteristic may include a first aggressor reference signal transmitted by the network node 704, and may be represented as h_{A-V}c₁₁s, where h_{A-V} is the communication channel between the network node 704 and the network node 702, c₁₁ is first pre-coding information (e.g., a first pre-coding vector) associated with the channel h_{A-V}, and s is a configured CLI resource (e.g., an SRS resource). In some aspects, the network node 704 may receive at least one additional signal. The at least one additional signal may include at least one additional signal characteristic associated with the first communication channel. For example, the at least one additional signal characteristic may include a second aggressor reference signal transmitted by the network node 704, and may be represented as h_{A-V}c₂₁s, where h_{A-V} is the first communication channel, between the network node 704 and the network node 702, c₂₁ is second pre-coding information (e.g., a pre-coding vector) associated with the channel h_{A-V}, and s is a configured CLI resource (e.g., an SRS resource) associated with the second aggressor reference signal.

The signal also may include a second signal characteristic 720 associated with a second pre-coding vector corresponding to a second communication channel between the network node 704 and the network node 706. The second signal characteristic may be referred to as a “first reflected reference signal,” and may be pre-coded by third pre-coding information (e.g., a third pre-coding vector). For example, the first reflected reference signal may be represented as h_{A-I-V}c₁₂s, where h_{A-I-V} is the second communication channel, between the network node 704 and the network node 706, c₁₂ is third pre-coding information, and s is a configured CLI resource associated with the first reflected reference signal. The at least one additional signal may include a fourth reflected reference signal, transmitted from the network node 708 (e.g., as a reflection of a transmission from the network node 702). The fourth reflected reference signal may be pre-coded using fourth pre-coding information c₂₂ and may be represented by h_{A-I-V}c₂₂s. In some aspects, the first aggressor reference signal and the first reflected reference signal may overlap in time (e.g., a partial overlap in time or a full overlap in time), and the second aggressor reference signal and the second reflected reference signal may overlap in time (e.g., a partial overlap in time or a full overlap in time).

Thus, the signal, which may be a first transmission (T₁) of a number of transmissions received by the network node 704 may be represented as y_{T1}=HC_{T1}=h_{A-V}c₁₁s+h_{A-I-V}c₁₂s, where H is the communication channel associated with the signal, s is the configured CLI resource, and C_{T1}={c₁₁, c₁₂} is a pre-coding vector associated with the communication channel H at the first transmission T₁. At time T₂, the network node 704 may receive the at least one additional signal y_{T2}=HC_{T2}=h_{A-V}c₂₁s+h_{A-I-V}c₂₂s, where the pre-coding vector is defined as C_{T2}={c₂₁, c₂₂}.

As shown by reference number 722, the network node 704 may generate channel estimation information. The channel estimation information may include first channel estimation information and second channel estimation information. The first channel estimation information may correspond to the first communication channel and may be based on the first pre-coding vector, and the second channel estimation information may correspond to the second communication channel and may be based on a second pre-coding vector associated with the second communication channel. For example, the channel estimation information may be based on the plurality of aggressor reference signals and the plurality of reflected reference signals. The first channel information may be indicative of one or more channel characteristics corresponding to the first channel, and the second channel information may be indicative of one or more channel characteristics corresponding to the second channel. For example, in sum, Y={y_{T1}, y_{T2}}, where Y=HCs, and where, C={C_{T1}, C_{T2}} is a 2×2 matrix and can be made known to the network node 704 as a configuration and s is the configured CLI SRS resource. Since C and s may be both known to the network node 704, H can be estimated as Hₑₛₜ in general via any number of different matrix and/or algebraic math manipulations. For example, in some aspects, Hₑₛₜ=Y*Inverse(Cs).

As shown by reference number 724, the network node 704 may transmit, and the network node 702 may receive, the channel estimation information. In some aspects, the channel estimation information may include the first channel estimation information and the second channel estimation information. In some aspects, the channel estimation information may be based on the CLI configuration information. In some aspects, channel estimation may be configured to be reported as per-victim network node based channel estimation information. For example, a network node 704 may be configured (e.g., by the network node 702) to report channels from an indicated aggressor network node and an indicated electromagnetic radiation reflection relay network node.

In some aspects, for example, the first channel estimation information may include first raw channel estimation information and the second channel estimation information may include second raw channel estimation information. The first raw channel estimation information and the second raw channel estimation information may be non-differential information and non-quantized information. In some aspects, the first channel estimation information may be indicative of a first channel estimation value associated with the first communication channel, and the second channel estimation information may be a differential value indicative of a second channel estimation value. The differential value may be relative to the first channel estimation value. For example, in some aspects, the differential value may correspond to a ratio between h_{A-V-est} and h_{A-I-V-est}. In some aspects, the first channel estimation information may include first quantized channel estimation information, and the second channel estimation information may include second quantized channel estimation information. For example, the channel estimation information may include quantized versions of h_{A-V-est} and h_{A-I-V-est}, which may include single respective values indicating the respective channel estimations.

As shown by reference number 726, the network node 702 may determine reflection relay configuration information. For example, the reflection relay configuration information may include one or more electromagnetic reflection parameters based on the channel estimation information. In some aspects, the one or more electromagnetic reflection parameters may include at least one of a phase shift coefficient or an amplitude coefficient. In some aspects, the one or more electromagnetic reflection parameters may include one or more electromagnetic reflection parameters determined so as to mitigate CLI associated with at least one of the first communication channel or the second communication channel. For example, in some aspects, the network node 702 may determine the one or more electromagnetic reflection parameters to increase a signal strength associated with the second communication channel. In some aspects, the network node 702 may determine the one or more electromagnetic reflection parameters to decrease a signal strength associated with the second communication channel.

As shown by reference number 728, the network node 702 may transmit, and the network node 708 may receive, the reflection relay configuration information. The reflection relay configuration information may be indicative of the one or more electromagnetic reflection parameters based on the channel estimation information.

As indicated above, FIG. 7 is provided as an example. Other examples may differ from what is described with regard to FIG. 7. For example, in some aspects, aspects may be applied in a scenario involving two or more electromagnetic radiation reflection relay network nodes. For example, the dimensions of the pre-coding matrix C may be expanded such that the number of columns corresponds to the number of reference signal transmissions and the number of rows is scaled with the number of electromagnetic radiation reflection relay network nodes.

FIG. 8 is a diagram illustrating an example process 800 performed, for example, by a first network node, in accordance with the present disclosure. Example process 800 is an example where the first network node (e.g., the network node 704) performs operations associated with reporting CLI associated with an electromagnetic radiation reflection relay service.

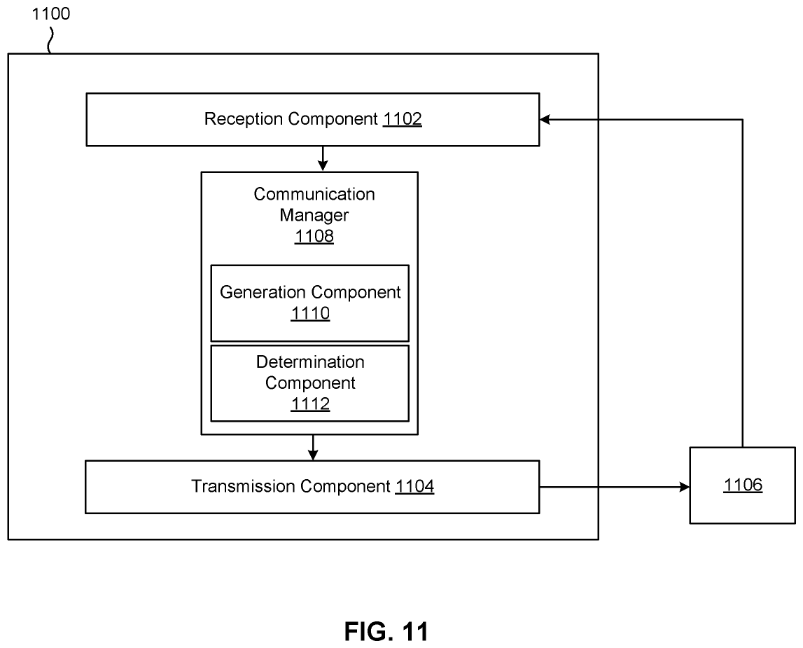

As shown in FIG. 8, in some aspects, process 800 may include receiving CLI configuration information (block 810). For example, the first network node (e.g., using communication manager 1108 and/or reception component 1102, depicted in FIG. 11) may receive CLI configuration information, as described above.

As further shown in FIG. 8, in some aspects, process 800 may include receiving a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node (block 820). For example, the first network node (e.g., using communication manager 1108 and/or reception component 1102, depicted in FIG. 11) may receive a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node, as described above. In some aspects, the signal comprises a reference signal. In some aspects, the reference signal comprises a sounding reference signal.

As further shown in FIG. 8, in some aspects, process 800 may include generating channel estimation information corresponding to the signal (block 830). For example, the first network node (e.g., using communication manager 1108 and/or generation component 1110, depicted in FIG. 11) may generate channel estimation information corresponding to the signal, as described above.

As further shown in FIG. 8, in some aspects, process 800 may include transmitting the channel estimation information corresponding to the signal, wherein the channel estimation information includes first channel estimation information and second channel estimation information, wherein the first channel estimation information corresponds to the first communication channel and is based on the first pre-coding vector, and the second channel estimation information corresponds to the second communication channel and is based on a second pre-coding vector associated with the second communication channel (block 840). For example, the first network node (e.g., using communication manager 1108 and/or transmission component 1104, depicted in FIG. 11) may transmit the channel estimation information corresponding to the signal, wherein the channel estimation information includes first channel estimation information and second channel estimation information, wherein the first channel estimation information corresponds to the first communication channel and is based on the first pre-coding vector, and the second channel estimation information corresponds to the second communication channel and is based on a second pre-coding vector associated with the second communication channel, as described above.

Process 800 may include additional aspects, such as any single aspect or any combination of aspects described below and/or in connection with one or more other processes described elsewhere herein.

In some aspects, process 800 includes receiving at least one additional signal comprising at least one additional signal characteristic associated with the first communication channel and at least one additional signal characteristic associated with the second communication channel, and generating the channel estimation information based on a plurality of signals that includes the signal and the at least one additional signal. In some aspects, generating the channel estimation information comprises performing one or more channel estimation measurements based on the plurality of signals.

In some aspects, process 800 includes receiving CLI configuration information including first information indicative of a reference signal resource, wherein the signal corresponds to the reference signal resource. In some aspects, the CLI configuration information includes second information indicative of a plurality of pre-coding vectors corresponding to a pre-coding matrix, and the plurality of pre-coding vectors includes the first pre-coding vector and the second pre-coding vector. In some aspects, the plurality of pre-coding vectors includes at least one additional pre-coding vector associated with at least one additional network node configured to provide at least one additional electromagnetic radiation reflection relay service. In some aspects, the first network node comprises a memory that includes non-signaled information stored thereon, wherein the non-signaled information includes the first pre-coding vector and the second pre-coding vector.

In some aspects, the first channel estimation information is first raw channel estimation information, and the second channel estimation information is second raw channel estimation information, wherein the first raw channel estimation information and the second raw channel estimation information is non-differential information and non-quantized information. In some aspects, the first channel estimation information is indicative of a first channel estimation value associated with the first communication channel, and the second channel estimation information is a differential value indicative of a second channel estimation value, and the differential value is relative to the first channel estimation value. In some aspects, the first channel estimation information is first quantized channel estimation information, and the second channel estimation information is second quantized channel estimation information.

In some aspects, process 800 includes receiving CLI configuration information that specifies the second network node and the electromagnetic radiation reflection relay network node, and the second channel estimation information is based on the CLI configuration information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a first network node, in accordance with the present disclosure. Example process 900 is an example where the first network node (e.g., the network node 702) performs operations associated with reporting CLI associated with an electromagnetic radiation reflection relay service.

As shown in FIG. 9, in some aspects, process 900 may include transmitting CLI configuration information that includes first information indicative of a reference signal resource (block 910). For example, the first network node (e.g., using communication manager 1108 and/or transmission component 1104, depicted in FIG. 11) may transmit CLI configuration information that includes first information indicative of a reference signal resource, as described above.

As further shown in FIG. 9, in some aspects, process 900 may include receiving channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and the second channel estimation information corresponds to a second communication channel between an electromagnetic radiation reflection relay network node and the third network node and is based on a second pre-coding vector associated with the second communication channel (block 920). For example, the first network node (e.g., using communication manager 1108 and/or reception component 1102, depicted in FIG. 11) may receive channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and the second channel estimation information corresponds to a second communication channel between an electromagnetic radiation reflection relay network node and the third network node and is based on a second pre-coding vector associated with the second communication channel, as described above.

As further shown in FIG. 9, in some aspects, process 900 may include determining one or more electromagnetic reflection parameters based on the channel estimation information (block 930). For example, the first network node (e.g., using communication manager 1108 and/or determination component 1112, depicted in FIG. 11) may determine one or more electromagnetic reflection parameters based on the channel estimation information, as described above.

As further shown in FIG. 9, in some aspects, process 900 may include transmitting reflection relay configuration information to the electromagnetic radiation reflection relay network node, wherein the reflection relay configuration information is indicative of the one or more electromagnetic reflection parameters based on the channel estimation information (block 940). For example, the first network node (e.g., using communication manager 1108 and/or transmission component 1104, depicted in FIG. 11) may transmit reflection relay configuration information to the electromagnetic radiation reflection relay network node, wherein the reflection relay configuration information is indicative of the one or more electromagnetic reflection parameters based on the channel estimation information, as described above.

Process 900 may include additional aspects, such as any single aspect or any combination of aspects described below and/or in connection with one or more other processes described elsewhere herein.

In some aspects, determining the one or more electromagnetic reflection parameters comprises determining at least one of a phase shift coefficient or an amplitude coefficient. In some aspects, determining the one or more electromagnetic reflection parameters comprises determining the one or more electromagnetic reflection parameters to mitigate CLI associated with at least one of the first communication channel or the second communication channel. In some aspects, determining the one or more electromagnetic reflection parameters comprises determining the one or more electromagnetic reflection parameters to increase a signal strength associated with the second communication channel. In some aspects, determining the one or more electromagnetic reflection parameters comprises determining the one or more electromagnetic reflection parameters to decrease a signal strength associated with the second communication channel.

In some aspects, the CLI configuration information includes second information indicative of a plurality of pre-coding vectors corresponding to a pre-coding matrix, and the plurality of pre-coding vectors includes the first pre-coding vector and the second pre-coding vector. In some aspects, the plurality of pre-coding vectors includes at least one additional pre-coding vector associated with at least one additional network node configured to provide at least one additional electromagnetic radiation reflection relay service. In some aspects, the first network node comprises a memory that includes non-signaled information stored thereon, wherein the non-signaled information includes the first pre-coding vector and the second pre-coding vector.

In some aspects, the first channel estimation information is first raw channel estimation information, and the second channel estimation information is second raw channel estimation information, wherein the first raw channel estimation information and the second raw channel estimation information is non-differential information and non-quantized information. In some aspects, the first channel estimation information is indicative of a first channel estimation value associated with the first communication channel, and the second channel estimation information is a differential value indicative of a second channel estimation value, and the differential value is relative to the first channel estimation value. In some aspects, the first channel estimation information is first quantized channel estimation information, and the second channel estimation information is second quantized channel estimation information.

In some aspects, process 900 includes transmitting CLI configuration information that specifies the third network node and the electromagnetic radiation reflection relay network node, and the channel estimation information corresponds to the third network node and the electromagnetic radiation reflection relay network node based on the CLI configuration information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first network node, in accordance with the present disclosure. Example process 1000 is an example where the first network node (e.g., the network node 704) performs operations associated with reporting CLI associated with an electromagnetic radiation reflection relay service.

As shown in FIG. 10, in some aspects, process 1000 may include receiving CLI configuration information (block 1010). For example, the first network node (e.g., using communication manager 1108 and/or reception component 1102, depicted in FIG. 11) may receive CLI configuration information, as described above.

As further shown in FIG. 10, in some aspects, process 1000 may include receiving, from an aggressor network node, a plurality of aggressor reference signals, wherein the plurality of aggressor reference signals includes a first aggressor reference signal pre-coded by first pre-coding information and a second aggressor reference signal pre-coded by second pre-coding information (block 1020). For example, the first network node (e.g., using communication manager 1108 and/or reception component 1102, depicted in FIG. 11) may receive, from an aggressor network node, a plurality of aggressor reference signals, wherein the plurality of aggressor reference signals includes a first aggressor reference signal pre-coded by first pre-coding information and a second aggressor reference signal pre-coded by second pre-coding information, as described above.

As further shown in FIG. 10, in some aspects, process 1000 may include receiving, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time (block 1030). For example, the first network node (e.g., using communication manager 1108 and/or reception component 1102, depicted in FIG. 11) may receive, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time, as described above.

As further shown in FIG. 10, in some aspects, process 1000 may include generating channel estimation information based on the plurality of aggressor reference signals and the plurality of reflected reference signals (block 1040). For example, the first network node (e.g., using communication manager 1108 and/or generation component 1110, depicted in FIG. 11) may generate channel estimation information based on the plurality of aggressor reference signals and the plurality of reflected reference signals, as described above.

As further shown in FIG. 10, in some aspects, process 1000 may include transmitting, to a second network node, the channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and the second channel information is indicative of one or more channel characteristics corresponding to a second channel between the first network node and the electromagnetic radiation reflection relay network node (block 1050). For example, the first network node (e.g., using communication manager 1108 and/or transmission component 1104, depicted in FIG. 11) may transmit, to a second network node, the channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and the second channel information is indicative of one or more channel characteristics corresponding to a second channel between the first network node and the electromagnetic radiation reflection relay network node, as described above.

Process 1000 may include additional aspects, such as any single aspect or any combination of aspects described below and/or in connection with one or more other processes described elsewhere herein.

In some aspects, each respective reference signal of the plurality of aggressor reference signals comprises a respective sounding reference signal, and each respective reference signal of the plurality of reflected reference signals comprises a respective sounding reference signal. In some aspects, process 1000 includes generating the channel estimation information based on the plurality of aggressor reference signals and the plurality of reflected reference signals.

In some aspects, generating the channel estimation information comprises performing one or more channel estimation measurements based on the plurality of aggressor reference signals and the plurality of reflected reference signals. In some aspects, the CLI configuration information includes first information indicative of a plurality of reference signal resources, wherein the plurality of aggressor reference signals and the plurality of reflected reference signals correspond to the plurality of reference signal resources. In some aspects, the CLI configuration information includes second information indicative of a plurality of pre-coding vectors corresponding to a pre-coding matrix, and the plurality of pre-coding vectors includes the first pre-coding information, the second pre-coding information, the third pre-coding information, and the fourth pre-coding information. In some aspects, the plurality of pre-coding vectors includes at least one pre-coding vector corresponding to additional pre-coding information associated with at least one additional network node configured to provide at least one additional electromagnetic radiation reflection relay service.

In some aspects, the CLI configuration information specifies the aggressor network node and the electromagnetic radiation reflection relay network node, and the channel estimation information corresponds to the first channel and the second channel based on the CLI configuration information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108. The communication manager 1108 may include one or more of a generation component 1110, or a determination component 1112, among other examples.

In some aspects, the apparatus 1100 may be configured to perform one or more operations described herein in connection with FIG. 7. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of one or more of the network nodes described in connection with FIG. 4. Additionally, or alternatively, one or more components shown in FIG. 11 may be implemented within one or more components described in connection with FIG. 4. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of one or more of the network nodes described in connection with FIG. 4.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of one or more of the network nodes described in connection with FIG. 4. In some aspects, the transmission component 1104 may be co-located with the reception component 1102 in a transceiver.

The communication manager 1108 and/or the reception component 1102 may receive CLI configuration information. In some aspects, the communication manager 1108 may include one or more antennas, a modem, a controller/processor, a memory, or a combination thereof, of one or more of the network nodes described in connection with FIG. 4. In some aspects, the communication manager 1108 may include the reception component 1102 and/or the transmission component 1104. In some aspects, the communication manager 1108 may be, be similar to, include, or be included in, the communication manager 340 and/or 350 depicted in FIGS. 3 and 4.

The communication manager 1108 and/or the reception component 1102 may receive a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node.

The communication manager 1108 and/or the generation component 1110 may generate channel estimation information corresponding to the signal. In some aspects, the generation component 1110 may include one or more antennas, a modem, a controller/processor, a memory, or a combination thereof, of one or more of the network nodes described in connection with FIG. 4. In some aspects, the generation component 1110 may include the reception component 1102 and/or the transmission component 1104.

The communication manager 1108 and/or the transmission component 1104 may transmit the channel estimation information corresponding to the signal, wherein the channel estimation information includes first channel estimation information and second channel estimation information, wherein the first channel estimation information corresponds to the first communication channel and is based on the first pre-coding vector, and the second channel estimation information corresponds to the second communication channel and is based on a second pre-coding vector associated with the second communication channel. The communication manager 1108 and/or the reception component 1102 may receive at least one additional signal comprising at least one additional signal characteristic associated with the first communication channel and at least one additional signal characteristic associated with the second communication channel.

The communication manager 1108 and/or the generation component 1110 may generate the channel estimation information based on a plurality of signals that includes the signal and the at least one additional signal. The communication manager 1108 and/or the reception component 1102 may receive CLI configuration information including first information indicative of a reference signal resource, wherein the signal corresponds to the reference signal resource. The communication manager 1108 and/or the reception component 1102 may receive CLI configuration information that specifies the second network node and the electromagnetic radiation reflection relay network node, and the second channel estimation information is based on the CLI configuration information.

The communication manager 1108 and/or the transmission component 1104 may transmit CLI configuration information that includes first information indicative of a reference signal resource. The reception component 1102 may receive channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and the second channel estimation information corresponds to a second communication channel between an electromagnetic radiation reflection relay network node and the third network node and is based on a second pre-coding vector associated with the second communication channel.

The communication manager 1108 and/or the determination component 1112 may determine one or more electromagnetic reflection parameters based on the channel estimation information. In some aspects, the determination component 1112 may include one or more antennas, a modem, a controller/processor, a memory, or a combination thereof, of one or more of the network nodes described in connection with FIG. 4. In some aspects, the determination component 1112 may include the reception component 1102 and/or the transmission component 1104.

The communication manager 1108 and/or the transmission component 1104 may transmit reflection relay configuration information to the electromagnetic radiation reflection relay network node, wherein the reflection relay configuration information is indicative of the one or more electromagnetic reflection parameters based on the channel estimation information. The communication manager 1108 and/or the transmission component 1104 may transmit CLI configuration information that specifies the third network node and the electromagnetic radiation reflection relay network node, and the channel estimation information corresponds to the third network node and the electromagnetic radiation reflection relay network node based on the CLI configuration information.

The communication manager 1108 and/or the reception component 1102 may receive CLI configuration information. The communication manager 1108 and/or the reception component 1102 may receive, from an aggressor network node, a plurality of aggressor reference signals, wherein the plurality of aggressor reference signals includes a first aggressor reference signal pre-coded by first pre-coding information and a second aggressor reference signal pre-coded by second pre-coding information. The communication manager 1108 and/or the reception component 1102 may receive, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time.

The communication manager 1108 and/or the generation component 1110 may generate channel estimation information based on the plurality of aggressor reference signals and the plurality of reflected reference signals. The communication manager 1108 and/or the transmission component 1104 may transmit, to a second network node, the channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and the second channel information is indicative of one or more channel characteristics corresponding to a second channel between the first network node and the electromagnetic radiation reflection relay network node. The communication manager 1108 and/or the generation component 1110 may generate the channel estimation information based on the plurality of aggressor reference signals and the plurality of reflected reference signals.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a first network node, comprising: receiving a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node; and transmitting channel estimation information corresponding to the signal, wherein the channel estimation information includes first channel estimation information and second channel estimation information, wherein the first channel estimation information corresponds to the first communication channel and is based on the first pre-coding vector, and wherein the second channel estimation information corresponds to the second communication channel and is based on a second pre-coding vector associated with the second communication channel.

Aspect 2: The method of Aspect 1, wherein the signal comprises a reference signal.

Aspect 3: The method of Aspect 2, wherein the reference signal comprises a sounding reference signal.

Aspect 4: The method of any of Aspects 1-3, further comprising: receiving at least one additional signal comprising at least one additional signal characteristic associated with the first communication channel and at least one additional signal characteristic associated with the second communication channel; and generating the channel estimation information based on a plurality of signals that includes the signal and the at least one additional signal.

Aspect 5: The method of Aspect 4, wherein generating the channel estimation information comprises performing one or more channel estimation measurements based on the plurality of signals.

Aspect 6: The method of any of Aspects 1-5, further comprising receiving cross-link interference (CLI) configuration information including first information indicative of a reference signal resource, wherein the signal corresponds to the reference signal resource.

Aspect 7: The method of Aspect 6, wherein the CLI configuration information includes second information indicative of a plurality of pre-coding vectors corresponding to a pre-coding matrix, and wherein the plurality of pre-coding vectors includes the first pre-coding vector and the second pre-coding vector.

Aspect 8: The method of Aspect 7, wherein the plurality of pre-coding vectors includes at least one additional pre-coding vector associated with at least one additional network node configured to provide at least one additional electromagnetic radiation reflection relay service.

Aspect 9: The method of any of Aspects 1-8, wherein the first network node comprises a memory that includes non-signaled information stored thereon, wherein the non-signaled information includes the first pre-coding vector and the second pre-coding vector.

Aspect 10: The method of any of Aspects 1-9, wherein the first channel estimation information is first raw channel estimation information and the second channel estimation information is second raw channel estimation information, wherein the first raw channel estimation information and the second raw channel estimation information is non-differential information and non-quantized information.

Aspect 11: The method of any of Aspects 1-9, wherein the first channel estimation information is indicative of a first channel estimation value associated with the first communication channel, and the second channel estimation information is a differential value indicative of a second channel estimation value, and wherein the differential value is relative to the first channel estimation value.

Aspect 12: The method of any of Aspects 1-9 or 11, wherein the first channel estimation information is first quantized channel estimation information, and wherein the second channel estimation information is second quantized channel estimation information.

Aspect 13: The method of any of Aspects 1-12, further comprising receiving cross-link interference (CLI) configuration information that specifies the second network node and the electromagnetic radiation reflection relay network node, and wherein the second channel estimation information is based on the CLI configuration information.

Aspect 14: A method of wireless communication performed by a first network node, comprising: transmitting cross-link interference (CLI) configuration information that includes first information indicative of a reference signal resource; receiving channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and wherein the second channel estimation information corresponds to a second communication channel between an electromagnetic radiation reflection relay network node and the third network node and is based on a second pre-coding vector associated with the second communication channel; and transmitting reflection relay configuration information to the electromagnetic radiation reflection relay network node, wherein the reflection relay configuration information is indicative of one or more electromagnetic reflection parameters based on the channel estimation information.

Aspect 15: The method of Aspect 14, further comprising determining the one or more electromagnetic reflection parameters based on the channel estimation information.

Aspect 16: The method of either of Aspects 14 or 15, wherein determining the one or more electromagnetic reflection parameters comprises determining at least one of a phase shift coefficient or an amplitude coefficient.

Aspect 17: The method of any of Aspects 14-16, wherein determining the one or more electromagnetic reflection parameters comprises determining the one or more electromagnetic reflection parameters to mitigate CLI associated with at least one of the first communication channel or the second communication channel.

Aspect 18: The method of any of Aspects 14-17, wherein determining the one or more electromagnetic reflection parameters comprises determining the one or more electromagnetic reflection parameters to increase a signal strength associated with the second communication channel.

Aspect 19: The method of any of Aspects 14-17, wherein determining the one or more electromagnetic reflection parameters comprises determining the one or more electromagnetic reflection parameters to decrease a signal strength associated with the second communication channel.

Aspect 20: The method of any of Aspects 14-19, wherein the CLI configuration information includes second information indicative of a plurality of pre-coding vectors corresponding to a pre-coding matrix, and wherein the plurality of pre-coding vectors includes the first pre-coding vector and the second pre-coding vector.

Aspect 21: The method of Aspect 20, wherein the plurality of pre-coding vectors includes at least one additional pre-coding vector associated with at least one additional network node configured to provide at least one additional electromagnetic radiation reflection relay service.

Aspect 22: The method of any of Aspects 14-21, wherein the first network node comprises a memory that includes non-signaled information stored thereon, wherein the non-signaled information includes the first pre-coding vector and the second pre-coding vector.

Aspect 23: The method of any of Aspects 14-22, wherein the first channel estimation information is first raw channel estimation information and the second channel estimation information is second raw channel estimation information, wherein the first raw channel estimation information and the second raw channel estimation information is non-differential information and non-quantized information.

Aspect 24: The method of any of Aspects 14-22, wherein the first channel estimation information is indicative of a first channel estimation value associated with the first communication channel, and the second channel estimation information is a differential value indicative of a second channel estimation value, and wherein the differential value is relative to the first channel estimation value.

Aspect 25: The method of any of Aspects 14-22 or 23, wherein the first channel estimation information is first quantized channel estimation information, and wherein the second channel estimation information is second quantized channel estimation information.

Aspect 26: The method of any of Aspects 14-25, further comprising transmitting cross-link interference (CLI) configuration information that specifies the third network node and the electromagnetic radiation reflection relay network node, and wherein the channel estimation information corresponds to the third network node and the electromagnetic radiation reflection relay network node based on the CLI configuration information.

Aspect 27: A method of wireless communication performed by a first network node, comprising: receiving, from an aggressor network node, a plurality of aggressor reference signals, wherein the plurality of aggressor reference signals includes a first aggressor reference signal pre-coded by first pre-coding information and a second aggressor reference signal pre-coded by second pre-coding information; receiving, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time; and transmitting, to a second network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and wherein the second channel information is indicative of one or more channel characteristics corresponding to a second channel between the first network node and the electromagnetic radiation reflection relay network node.

Aspect 28: The method of Aspect 27, wherein each respective reference signal of the plurality of aggressor reference signals comprises a respective sounding reference signal, and wherein each respective reference signal of the plurality of reflected reference signals comprises a respective sounding reference signal.

Aspect 29: The method of either of Aspects 27 or 28, further comprising generating the channel estimation information based on the plurality of aggressor reference signals and the plurality of reflected reference signals.

Aspect 30: The method of Aspect 29, wherein generating the channel estimation information comprises performing one or more channel estimation measurements based on the plurality of aggressor reference signals and the plurality of reflected reference signals.

Aspect 31: The method of any of Aspects 27-30, wherein further comprising receiving cross-link interference (CLI) configuration information including first information indicative of a plurality of reference signal resources, wherein the plurality of aggressor reference signals and the plurality of reflected reference signals correspond to the plurality of reference signal resources.

Aspect 32: The method of Aspect 31, wherein the CLI configuration information includes second information indicative of a plurality of pre-coding vectors corresponding to a pre-coding matrix, and wherein the plurality of pre-coding vectors includes the first pre-coding information, the second pre-coding information, the third pre-coding information, and the fourth pre-coding information.

Aspect 33: The method of Aspect 32, wherein the plurality of pre-coding vectors includes at least one pre-coding vector corresponding to additional pre-coding information associated with at least one additional network node configured to provide at least one additional electromagnetic radiation reflection relay service.

Aspect 34: The method of any of Aspects 27-33, further comprising receiving cross-link interference (CLI) configuration information that specifies the aggressor network node and the electromagnetic radiation reflection relay network node, and wherein the channel estimation information corresponds to the first channel and the second channel based on the CLI configuration information.

Aspect 35: An apparatus for wireless communication at a device, comprising a processor; memory coupled with the processor; and instructions stored in the memory and executable by the processor to cause the apparatus to perform the method of one or more of Aspects 1-13.

Aspect 36: A device for wireless communication, comprising a memory and one or more processors coupled to the memory, the one or more processors configured to perform the method of one or more of Aspects 1-13.

Aspect 37: An apparatus for wireless communication, comprising at least one means for performing the method of one or more of Aspects 1-13.

Aspect 38: A non-transitory computer-readable medium storing code for wireless communication, the code comprising instructions executable by a processor to perform the method of one or more of Aspects 1-13.

Aspect 39: A non-transitory computer-readable medium storing a set of instructions for wireless communication, the set of instructions comprising one or more instructions that, when executed by one or more processors of a device, cause the device to perform the method of one or more of Aspects 1-13.

Aspect 40: An apparatus for wireless communication at a device, comprising a processor; memory coupled with the processor; and instructions stored in the memory and executable by the processor to cause the apparatus to perform the method of one or more of Aspects 14-26.

Aspect 41: A device for wireless communication, comprising a memory and one or more processors coupled to the memory, the one or more processors configured to perform the method of one or more of Aspects 14-26.

Aspect 42: An apparatus for wireless communication, comprising at least one means for performing the method of one or more of Aspects 14-26.

Aspect 43: A non-transitory computer-readable medium storing code for wireless communication, the code comprising instructions executable by a processor to perform the method of one or more of Aspects 14-26.

Aspect 44: A non-transitory computer-readable medium storing a set of instructions for wireless communication, the set of instructions comprising one or more instructions that, when executed by one or more processors of a device, cause the device to perform the method of one or more of Aspects 14-26.

Aspect 45: An apparatus for wireless communication at a device, comprising a processor; memory coupled with the processor; and instructions stored in the memory and executable by the processor to cause the apparatus to perform the method of one or more of Aspects 27-34.

Aspect 46: A device for wireless communication, comprising a memory and one or more processors coupled to the memory, the one or more processors configured to perform the method of one or more of Aspects 27-34.

Aspect 47: An apparatus for wireless communication, comprising at least one means for performing the method of one or more of Aspects 27-34.

Aspect 48: A non-transitory computer-readable medium storing code for wireless communication, the code comprising instructions executable by a processor to perform the method of one or more of Aspects 27-34.

Aspect 49: A non-transitory computer-readable medium storing a set of instructions for wireless communication, the set of instructions comprising one or more instructions that, when executed by one or more processors of a device, cause the device to perform the method of one or more of Aspects 27-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

What is claimed is:

1. A first network node for wireless communication, comprising:
a memory; and
at least one processor coupled to the memory, wherein the at least one processor is configured to:
receive a signal comprising a first signal characteristic associated with a first pre-coding vector corresponding to a first communication channel between the first network node and a second network node and a second signal characteristic associated with a second pre-coding vector corresponding to a second communication channel between the first network node and an electromagnetic radiation reflection relay network node; and
transmit channel estimation information corresponding to the signal, wherein the channel estimation information includes first channel estimation information and second channel estimation information, wherein the first channel estimation information corresponds to the first communication channel and is based on the first pre-coding vector, and wherein the second channel estimation information corresponds to the second communication channel and is based on a second pre-coding vector associated with the second communication channel.

2. The first network node of claim 1, wherein the signal comprises a reference signal.

3. The first network node of claim 2, wherein the reference signal comprises a sounding reference signal.

4. The first network node of claim 1, wherein the at least one processor is further configured to:
receive at least one additional signal comprising at least one additional signal characteristic associated with the first communication channel and at least one additional signal characteristic associated with the second communication channel; and
generate the channel estimation information based on a plurality of signals that includes the signal and the at least one additional signal.

5. The first network node of claim 4, wherein the at least one processor, to generate the channel estimation information, is configured to perform one or more channel estimation measurements based on the plurality of signals.

6. The first network node of claim 1, wherein the at least one processor is further configured to receive cross-link interference (CLI) configuration information including first information indicative of a reference signal resource, wherein the signal corresponds to the reference signal resource.

7. The first network node of claim 6, wherein the CLI configuration information includes second information indicative of a plurality of pre-coding vectors corresponding to a pre-coding matrix, and wherein the plurality of pre-coding vectors includes the first pre-coding vector and the second pre-coding vector.

8. The first network node of claim 7, wherein the plurality of pre-coding vectors includes at least one additional pre-coding vector associated with at least one additional network node configured to provide at least one additional electromagnetic radiation reflection relay service.

9. The first network node of claim 1, wherein the memory includes non-signaled information stored thereon, wherein the non-signaled information includes the first pre-coding vector and the second pre-coding vector.

10. The first network node of claim 1, wherein the first channel estimation information is first raw channel estimation information and the second channel estimation information is second raw channel estimation information, wherein the first raw channel estimation information and the second raw channel estimation information is non-differential information and non-quantized information.

11. The first network node of claim 1, wherein the first channel estimation information is indicative of a first channel estimation value associated with the first communication channel, and the second channel estimation information is a differential value indicative of a second channel estimation value, and wherein the differential value is relative to the first channel estimation value.

12. The first network node of claim 1, wherein the first channel estimation information is first quantized channel estimation information, and wherein the second channel estimation information is second quantized channel estimation information.

13. The first network node of claim 1, wherein the at least one processor is further configured to receive cross-link interference (CLI) configuration information that specifies the second network node and the electromagnetic radiation reflection relay network node, and wherein the second channel estimation information is based on the CLI configuration information.

14. A first network node for wireless communication, comprising:
a memory; and
at least one processor coupled to the memory, wherein the at least one processor is configured to:
transmit cross-link interference (CLI) configuration information that includes first information indicative of a reference signal resource;
receive channel estimation information corresponding to a signal that is based on the reference signal resource, wherein the channel estimation information includes first channel estimation information and second channel estimation information, wherein the first channel estimation information corresponds to a first communication channel between a second network node and a third network node and is based on a first pre-coding vector associated with the first communication channel, and wherein the second channel estimation information corresponds to a second communication channel between an electromagnetic radiation reflection relay network node and the third network node and is based on a second pre-coding vector associated with the second communication channel; and
transmit reflection relay configuration information to the electromagnetic radiation reflection relay network node, wherein the reflection relay configuration information is indicative of one or more electromagnetic reflection parameters based on the channel estimation information.

15. The first network node of claim 14, wherein the at least one processor is further configured to determine the one or more electromagnetic reflection parameters based on the channel estimation information.

16. The first network node of claim 14, wherein the at least one processor, to determine the one or more electromagnetic reflection parameters, is configured to determine at least one of a phase shift coefficient or an amplitude coefficient.

17. The first network node of claim 14, wherein the at least one processor, to determine the one or more electromagnetic reflection parameters, is configured to determine the one or more electromagnetic reflection parameters to mitigate CLI associated with at least one of the first communication channel or the second communication channel.

18. The first network node of claim 14, wherein the at least one processor, to determine the one or more electromagnetic reflection parameters, is configured to determine the one or more electromagnetic reflection parameters to increase a signal strength associated with the second communication channel.

19. The first network node of claim 14, wherein the at least one processor, to determine the one or more electromagnetic reflection parameters, is configured to determine the one or more electromagnetic reflection parameters to decrease a signal strength associated with the second communication channel.

20. The first network node of claim 14, wherein the CLI configuration information includes second information indicative of a plurality of pre-coding vectors corresponding to a pre-coding matrix, and wherein the plurality of pre-coding vectors includes the first pre-coding vector and the second pre-coding vector.

21. The first network node of claim 20, wherein the plurality of pre-coding vectors includes at least one additional pre-coding vector associated with at least one additional network node configured to provide at least one additional electromagnetic radiation reflection relay service.

22. The first network node of claim 14, wherein the memory includes non-signaled information stored thereon, wherein the non-signaled information includes the first pre-coding vector and the second pre-coding vector.

23. The first network node of claim 14, wherein the first channel estimation information is first raw channel estimation information and the second channel estimation information is second raw channel estimation information, wherein the first raw channel estimation information and the second raw channel estimation information is non-differential information and non-quantized information.

24. The first network node of claim 14, wherein the first channel estimation information is indicative of a first channel estimation value associated with the first communication channel, and the second channel estimation information is a differential value indicative of a second channel estimation value, and wherein the differential value is relative to the first channel estimation value.

25. The first network node of claim 14, wherein the first channel estimation information is first quantized channel estimation information, and wherein the second channel estimation information is second quantized channel estimation information.

26. The first network node of claim 14, wherein the at least one processor is further configured to transmit cross-link interference (CLI) configuration information that specifies the third network node and the electromagnetic radiation reflection relay network node, and wherein the channel estimation information corresponds to the third network node and the electromagnetic radiation reflection relay network node based on the CLI configuration information.

27. A first network node for wireless communication, comprising:
a memory; and
at least one processor coupled to the memory, wherein the at least one processor is configured to:
receive, from an aggressor network node, a plurality of aggressor reference signals, wherein the plurality of aggressor reference signals includes a first aggressor reference signal pre-coded by first pre-coding information and a second aggressor reference signal pre-coded by second pre-coding information;
receive, from an electromagnetic radiation reflection relay network node, a plurality of reflected reference signals, wherein the plurality of reflected reference signals includes a first reflected reference signal pre-coded by third pre-coding information and a second reflected reference signal pre-coded by fourth pre-coding information, wherein the first aggressor reference signal and the first reflected reference signal overlap in time, and the second aggressor reference signal and the second reflected reference signal overlap in time; and
transmit, to a second network node, channel estimation information including first channel estimation information and second channel estimation information, wherein the channel estimation information is based on the plurality of aggressor reference signals and the plurality of reflected reference signals, wherein the first channel information is indicative of one or more channel characteristics corresponding to a first channel between the first network node and the aggressor network node, and wherein the second channel information is indicative of one or more channel characteristics corresponding to a second channel between the first network node and the electromagnetic radiation reflection relay network node.

28. The first network node of claim 27, wherein each respective reference signal of the plurality of aggressor reference signals comprises a respective sounding reference signal, and wherein each respective reference signal of the plurality of reflected reference signals comprises a respective sounding reference signal.

29. The first network node of claim 27, wherein the at least one processor is configured to generate the channel estimation information based on the plurality of aggressor reference signals and the plurality of reflected reference signals.

30. The first network node of claim 27, wherein the at least one processor is configured to receive cross-link interference (CLI) configuration information including first information indicative of a plurality of reference signal resources, wherein the plurality of aggressor reference signals and the plurality of reflected reference signals correspond to the plurality of reference signal resources, wherein the CLI configuration information includes second information indicative of a plurality of pre-coding vectors corresponding to a pre-coding matrix, and wherein the plurality of pre-coding vectors includes the first pre-coding information, the second pre-coding information, the third pre-coding information, and the fourth pre-coding information.
